(19) United States
(12) Patent Application Publication
(10) Pub. No.: US 2017/0018036 A1
(43) Pub. Date: Jan. 19, 2017

(54) SOCIAL NETWORKING ADVOCACY SYSTEM AND METHOD

(71) Applicant: BlastRoots, Inc., Washington, DC (US)

(72) Inventors: Christopher C. HULL, Washington, DC (US); John L. MERZ, Washington, DC (US); Timothy J. VICKEY, Erie, PA (US)

(21) Appl. No.: 15/012,818

(22) Filed: Feb. 1, 2016

Related U.S. Application Data
(63) Continuation of application No. 13/723,086, filed on Dec. 20, 2012, now abandoned.
(60) Provisional application No. 61/578,710, filed on Dec. 21, 2011.

(51) Int. Cl. G06Q 50/00; G06Q 10/10

(52) U.S. Cl. CPC G06Q 50/01; G06Q 10/10; H04L 51/32

(57) ABSTRACT

An online advocacy platform provides one or more of a crowd-sourced vote-counting mechanism for legislative issues, support on target selection, tactic prioritization, fundraising, supporter recruitment, campaign marketing, and content creation and aggregation. In some embodiments, the platform further provides one or more of group purchase of advocacy services and a social networking address book. According to some embodiments of the disclosure, computer-implemented methods for advocacy efforts using social networks may comprise providing an online site hosting information associated with an advocacy effort to influence a decision of a decision maker, providing, using a strategy calculator module, a plurality of advocacy actions available to influence the decision maker, receiving input selecting an advocacy action from an online user interface of the online site, and performing, using a fulfillment module, the selected advocacy action using one or more electronic actions to influence the decision maker.

### CROSS-REFERENCE TO RELATED APPLICATION

This application claims priority to, and incorporates by reference in its entirety, U.S. Provisional Patent Application No. 61/578,710, titled “Social Networking Advocacy System And Method” by Christopher C. Hull, et al., Attorney Docket No. BLAS-2011002, filed on Dec. 21, 2011.

### FIELD

The present disclosure relates to an online advocacy platform, and more particularly, to systems and methods for providing lobbying and advocacy tools to enable users to shape policy outcomes using social networking.

### BACKGROUND

Traditionally, lobbyists relied on hard-to-replicate personal relationships to gain access to decision makers and political leaders. Over time, the importance of government, the size of support staffs, and the centrality of fundraising to political success have all grown substantially. In response, the number of lobbyists and the types of advocacy have mushroomed. Today, lobbying is only one tool in an ever-expanding advocacy tool kit that includes public relations, grassroots advocacy, web mobilization, direct mail, telephone call generation, mass email contact, and social media.

As a result, while the number of participants in advocacy has expanded, the cost of truly effective lobbying has ballooned even further. That leaves wealthy liberal and conservative individuals, large corporations and trade groups, well-heeled advocacy groups on the left and right, and powerful labor unions and trial lawyers with the wherewithal and savvy to deploy effective lobbying campaigns that swamp other efforts.

Fears that lobbyists and the special interests that employ them wield an inordinate amount of socioeconomic power are growing, as elected officials become more dependent upon lobbyists for campaign contributions, and advocacy tools and technology available to special interest groups improve to simulate public support elected officials likewise need for reelection.

Among others, one fear is that this disproportionate power is enabling technically enhanced and/or highly connected lobbyists to disrupt the policy environment and thereby the economy and society through changes motivated by the narrow agendas of small groups, particular entities or special interests represented by those lobbyists.

For example, a financial crisis spurred by existing banking practices might be expected to give rise to policy changes focused on correcting those practices and preventing another crisis. Such legislation might require banks to maintain higher capital levels, separate federally insured depository institutions from high-risk investment entities, create long-term executive compensation clawbacks for failed short-term risk- taking, stiffen mortgage requirements to qualify for federal guarantees, and require more originated loans to remain on bank books. However, with a well-funded and well-connected lobbying team, the financial services industry might be able to counteract these expected consequences by replacing such policy changes with more palatable options that fail to address the original crisis, but provide sufficient cover to elected leaders as well as generating support in the form of campaign contributions. Since many of the groups affected by such a financial crisis likely do not include members capable of individually funding a competing lobbying group, financial reform advocates are hampered in their efforts to initiate, fund, and deploy a competing full-scale public affairs campaign. Accordingly, the lobbying and advocacy tools required to organize the financial reform constituents into a unified “grassroots” opposition are typically not available until after sufficient funds may be raised by existing organizations, which is often too late to stop pending legislation.

In this context, public demands across the ideological spectrum for elected officials to be more responsive continue to scale upwards in intensity to historic levels. Those demands include calls for increased accountability to America's grassroots, and reduced dependence on lobbyists and those who fund them.

### SUMMARY

An online advocacy platform provides one or more of a crowd-sourced vote-counting mechanism for legislative issues, support on target selection, tactic prioritization, fundraising, supporter recruitment, campaign marketing, and content creation and aggregation. In some embodiments, the platform further provides one or more of group purchase of advocacy services and a social networking address book. According to some embodiments of the disclosure, computer-implemented methods for advocacy efforts using social networks may comprise providing an online site hosting information associated with an advocacy effort to influence a decision of a decision maker; providing, using a strategy calculator module, a plurality of advocacy actions available to influence the decision maker; receiving input selecting an advocacy action from an online user interface of the online site; and performing, using a fulfillment module, the selected advocacy action using one or more electronic actions to influence the decision maker. The one or more electronic actions may comprise, for example, one or more of: generating an email, connecting a user to the decision maker using a VOIP based call, generating a tweet, generating a post to a social media site, sending an order for an online advertisement, sending a fax using a fax server, and generating a letter for postal delivery.

In some embodiments, the advocacy efforts may be part of an advocacy campaign to influence a vote. According to some aspects of the disclosure, methods may further comprise receiving crowd-sourced information associated with a suspected choice of the decision maker. Receiving crowd-sourced information may include receiving information to support the suspected choice comprising one or more of: receiving intelligence reports, documents, video, sound, and links Aspects of the disclosure may further comprise receiving, using a strategy calculator module, crowd-sourced information associated with a suspected decision of each of a plurality of decision makers related to the advocacy effort, and ranking, using the strategy calculator module, the plurality of decision makers related to the advocacy effort in order by priority. Ranking may be based on the value of campaigning for a particular decision maker's vote, a likelihood of influencing a vote of a particular legislator, or other factors.

In one or more embodiments, methods for social network advocacy systems may comprise counting, using the strategy calculator module, expected votes of each of the plurality of decision makers, and providing information on the online site related to the counted expected votes. Methods may further comprise recommending, using the strategy calculator module, one of the plurality of advocacy actions available to influence the decision maker based on an expected vote of the decision maker.

### BRIEF DESCRIPTION OF THE DRAWINGS

FIG. 1 illustrates a suitable operating environment for social networking advocacy systems in accordance with at least one embodiment.

FIG. 2 illustrates several components of an advocacy server in accordance with one embodiment.

FIG. 3 illustrates several components of an online advocacy platform in accordance with at least one embodiment.

FIG. 4 illustrates several components of an advocacy group purchasing system in accordance with one embodiment.

FIG. 5 illustrates a flow diagram of campaign product selection in a group purchasing routine for the advocacy group purchasing system shown in FIG. 4 in accordance with one embodiment.

FIG. 6 illustrates a flow diagram of campaign contribution allocation in a group purchasing routine for the advocacy group purchasing system shown in FIG. 4 in accordance with one embodiment.

FIG. 7 illustrates a flow diagram of campaign kitty distribution in a group purchasing routine for the advocacy group purchasing system shown in FIG. 4 in accordance with one embodiment.

FIG. 8 illustrates several components of an advocacy blast system in accordance with one embodiment.

FIG. 9 illustrates a flow diagram of campaign blast participant selection in a blast routine for the advocacy blast system shown in FIG. 8 in accordance with one embodiment.

FIG. 10 illustrates a series of communications between various devices generating a blast for a campaign in accordance with one embodiment.

FIG. 11 illustrates a flow diagram of campaign blast message compilation in a blast routine for the advocacy blast system shown in FIG. 8 in accordance with one embodiment.

FIG. 12 illustrates several components of an advocacy WikiWhip system in accordance with one embodiment.

FIG. 13 illustrates a flow diagram of a WikiWhip strategy calculator routine for the advocacy WikiWhip system shown in FIG. 12 in accordance with one embodiment.

FIG. 14 illustrates a screenshot prompting a new user to select a campaign in accordance with one embodiment.

FIG. 15 illustrates a screenshot of a new user log-in page prompting user registration for secure participation in a selected campaign in accordance with one embodiment.

FIG. 16 illustrates a screenshot of a combined member/new user log-in page in accordance with one embodiment.

FIG. 17 illustrates a screenshot of a new campaign management page prompting target and tactical selection for a selected campaign in accordance with one embodiment.

FIG. 18 illustrates a screenshot of a member dashboard with a consolidated aggregate campaign newsfeed drawn from a collection of member campaigns in accordance with one embodiment.

FIG. 19 illustrates a screenshot of another member dashboard populated with member campaigns in accordance with one embodiment.

FIG. 20 illustrates a screenshot of a topic-related campaign index for members in accordance with one embodiment.

FIG. 21 illustrates a screenshot of topic-related campaigns for member self-affiliation in accordance with one embodiment.

FIG. 22 illustrates a screenshot of a campaign profile in accordance with one embodiment.

FIG. 23 illustrates a screenshot of a campaign dashboard for campaign members with a campaign newsfeed in accordance with one embodiment.

FIG. 24 illustrates a screenshot of a campaign dashboard for campaign managers with a campaign newsfeed in accordance with one embodiment.

FIG. 25 illustrates a screenshot of a campaign budget dashboard for campaign managers in accordance with one embodiment.

FIG. 26 illustrates a screenshot of a campaign tactical advocacy strategy selection page for campaign managers in accordance with one embodiment.

FIG. 27 illustrates a screenshot of a blasted campaign content page in accordance with one embodiment.

FIG. 28 illustrates a blast box for social networking advocacy in accordance with one embodiment.

### DESCRIPTION

In accordance with various embodiments, a social networking advocacy service may provide members with grassroots advocacy campaign support through an online advocacy platform. Unlike other more limited advocacy tools that merely deliver messages from all constituents to their elected officials, the described social networking advocacy platform allows members of the public to create a multi-tactic campaign that targets specific decision-makers. For example, in one embodiment the advocacy platform helps a campaign manager with target selection, tactic prioritization, fundraising, supporter recruitment, campaign marketing, and campaign content creation and aggregation. Moreover, various embodiments allow campaign members to take action by donating directly to specific campaign objectives or donating generally to a campaign kitty managed by the campaign manager, by creating campaign content for consideration by campaign management, and by dissemination of selected campaign content to targeted social networks in accordance with campaign tactics. The advocacy tool also provides a way for individuals to draw attention and resources to policy concerns that may have been neglected, such as low-profile local issues that nonetheless merit addressing. As such, the tool gives groups a way to meet the minimum level of political capital to move policy that they would otherwise not be able to meet by themselves. BlastRoots (http://www.BlastRoots.com) provides commercial services based on an online advocacy platform that includes one embodiment of such a social networking advocacy service.

Various aspects of the illustrative embodiments will be described using terms commonly employed by those skilled in the art to convey the substance of their work to others skilled in the art. However, the embodiments described herein may be practiced with only some of the described aspects. For purposes of explanation, specific numbers, materials, and configurations may be set forth to provide a thorough understanding of the illustrative embodiments. However, the embodiments described herein may be practiced without the specific details. In other instances, well-known features are omitted or simplified in order not to obscure the illustrative embodiments.

The phrases “in one embodiment,” “in various embodiments,” “in some embodiments,” and the like are used repeatedly. Such phrases do not necessarily refer to the same embodiment, but they may unless the context dictates otherwise. The terms “comprising,” “having,” and “including” are synonymous, unless the context dictates otherwise. As used herein, “advocacy” is considered an essential part of a political process which aims to influence public-policy and resource allocation decisions within political, economic, and social systems and institutions. Advocacy may be motivated by moral, ethical or faith principles or simply a collective desire to protect an asset of interest. Advocacy can include many activities that a person or organization undertakes including media campaigns, public speaking, commissioning and publishing research or polling. There are a variety of different advocacy types including, but not limited to interest-group advocacy, legislative advocacy, budget advocacy, bureaucratic advocacy, health advocacy, ideological advocacy, mass advocacy, media advocacy, and the like. The term “advocacy group” as used herein refers to a formal organization or loose association of people, who seek to influence policy decisions, without (or apart from) seeking election to public office. The term “lobbying” as used generally herein usually refers to the process of engaging public officials and/or policymakers to persuade them on a given public policy issue. There are a variety of different lobbying types including, but not limited to, direct lobbying, grassroots lobbying or indirect lobbying, astroturf lobbying, and the like. Just as the different lobbying types are merely various tactical approaches to the same lobbying goal, lobbying itself may also be considered a subset of advocacy representing a particular tactical approach to the same advocacy goal. In one embodiment, lobbying may include a variety of activities that ask policymakers or others to take a specific position on a non-legislative matter, such that one can lobby a regulator about a regulation, or lobby a governor or the president about an executive order, or even lobby the general public for or against a ballot proposal. The term “campaign” as used herein is an organized effort directed by participating advocates to influence the decision making process within a specific organization or government body. A campaign may include multiple steps and use a variety of techniques to convey a particular message to targeted groups including advertising, debates or speeches, mass meetings, rallies, protests, e- mail, web sites, podcasts, and social media. Accordingly, advocacy, lobbying, and campaigning are often closely related, particularly within the political realm, but are not necessarily synonymous.

In one embodiment, the advocacy platform provides a list of tactics that may be selected and prioritized by a campaign manager for use and/or implementation during a particular campaign. Tactics may include Recruit Others, Mail Target, Tweet at Target (on Twitter), Message Target (on Facebook), Email Target, Call Target, Fax Target, Raise Money, Raise In-kind Support, Contribute to Candidate, Run Search Ads, Run Banner Ads, Run Newspaper Ads, Run Radio Ads, Make Auto Calls, Send Advocacy Mail, Generate News Coverage, Hire Grassroots Operative, Hire Lobbyist, Donate to Advocacy Group, and the like. Various embodiments may also use tactics that include Coalition Building by identifying new potential advocacy groups, Volunteer Phone Banking by using predictive dialing, Grasstops Identification by using donor reports and elected official lists, Targeted Email Blasts using large-scale lists of potential supporters targeted by districts, Live paid phones using a vendor for live operator outbound patch and/or give number calls, and Television Advertisements using a placement vendor.

The term “Blast” as used herein refers to a distribution of a message to multiple specified recipients. In one embodiment, a blast may include a variety of coordinated communication efforts made by managers or members, and/or selected campaign tactics used to convince, maintain, and/or acquire support for a campaign policy. In one embodiment, a blast sent by a campaign member performs the function of distributing selected campaign content along with customized member content to designated members of the campaign member's social networks. For example, a campaign member might authorize sending a campaign message coupled with their own personalized reaction to designated social networks of the member, such as Twitter and Facebook. Before blasting a communication out to the selected portions of a user's social network, the advocacy platform modifies the messages for each of the designated social networks. Where the term “wiki” normally refers to a crowd-sourced information site and the term “whip”, when used as an advocacy verb, means to move votes in a given direction within a legislative body, the combined term “WikiWhip” as used herein refers to a portion of the advocacy platform configured to crowd-source information on decision-makers' latest position on a given issue, in order to count their votes at any one time, rank them in priority for advocacy contact, and thereby automate selection of tactics recommended to users. In one embodiment, the WikiWhip provides a mechanism to allow users (members and managers) to add intelligence reports, documents, video, sound and other links to back up that ranking The WikiWhip automatically provides an advocacy tool to the online advocacy platform that allows for variable tactic selection based in part on a Whip Count within the campaign. A Whip Count may refer to a count of a number of Members of Congress (or some other group) inclined to vote either for or against a particular bill. The Whip Count may be based on suspected inclinations gathered using crowd-sourced information, media speculation, and/or statements of a Member of Congress (or other group).

The detailed description of the advocacy platform that follows is represented largely in terms of processes and symbolic representations of operations by conventional computer components, including a processor, memory storage devices for the processor, connected display devices and input devices. Furthermore, these processes and operations may utilize conventional computer components in a heterogeneous distributed computing environment; including remote file servers, computer servers, publishing resources, and/or memory storage devices. Each of these conventional distributed computing components is accessible by the processor via a communication network. In a heterogeneous distributed computing environment, clients, servers, and client/servers may be, for example, mainframes, minicomputers, workstations, or personal computers. Most services in a heterogeneous distributed computing environment can be grouped into one of these major categories: distributed file system, distributed computing resources, and messaging. A distributed file system provides transparent access to part of the mass storage of a remote network device, such as a server. Distributed computing resources provide access to computational or processing power of remote network devices, such as a cloud server. In one embodiment, distributed computing resources also provide a client with access to remote resources, such as printing/publication assets associated with remote network devices.

Further, various operations and/or communications may be described as multiple discrete operations and/or communications, in turn, in a manner that may be helpful in understanding the embodiments described herein; however, the order of description should not be construed as to imply that these operations and/or communications are necessarily order dependent. In particular, these operations and/or communications need not be performed in the order of presentation.

Reference is now made in detail to the description of the embodiments as illustrated in the drawings. Particular embodiments described in this application provide specific case implementations of advocacy for a particular campaign by helping with tactic selection, fundraising, group purchasing, lobbying, campaign marketing, campaign content aggregation, and monitoring decision-maker positions. While embodiments are described in connection with the drawings and related descriptions, there is no intent to limit the scope to the embodiments disclosed herein. On the contrary, the intent is to cover all alternatives, modifications, and equivalents. In alternate embodiments, additional devices, or combinations of illustrated devices, may be added to, or combined, without limiting the scope to the embodiments disclosed herein.

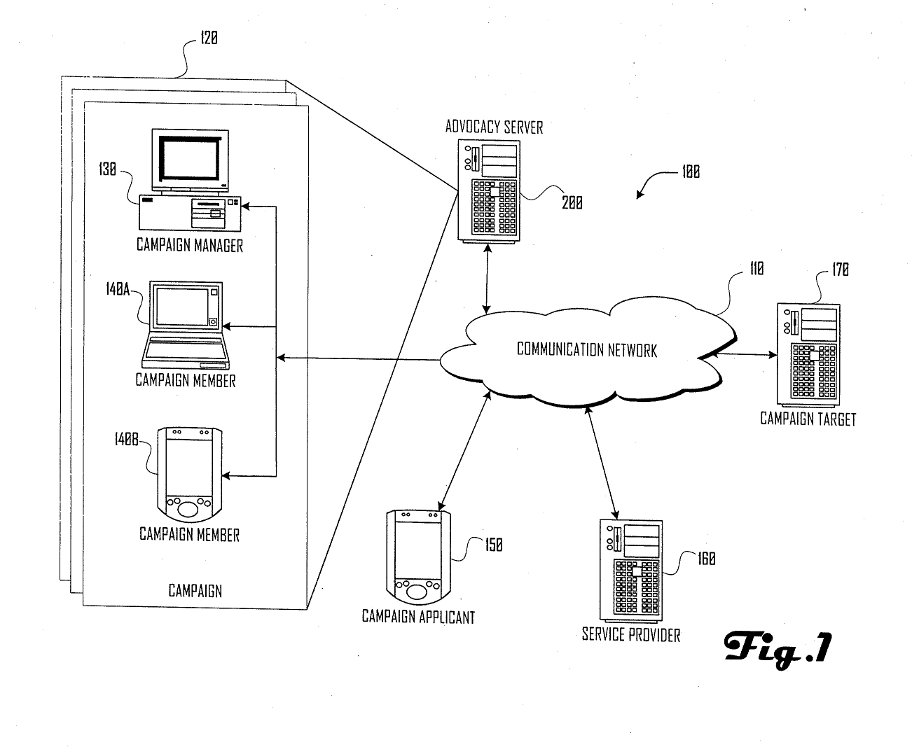

Referring now to FIG. 1, a suitable operating environment 100 for social networking advocacy systems is shown in accordance with at least one embodiment. The environment 100 may include participants in a campaign 120, campaign applicants 150, a third party service provider 160, and a campaign target 170 coupled via communications network 110 to an advocacy server 200. In one embodiment, the advocacy server 200 may support multiple campaigns; each campaign 120 may include at least one campaign manager 130 and at least one campaign member 140. The campaign 120 may also include a campaign database with campaign data, member data, advocacy content, member created content, and links to external content. In one embodiment, a campaign member may actively create campaign content (140A) and/or distribute campaign content (140B). One embodiment of the advocacy server 200 is provided by BlastRoots, Inc. (http://www.BlastRoots.com). The third party service provider 160 may include a variety of social media platforms including, among others, Facebook®, Twitter®, RSS, YouTube®, Yahoo®, Linkedln, StumbleUpon, Delicious, Technorati, Digg, Reddit, Furl, Flickr, Google+, Blogster, and the like.

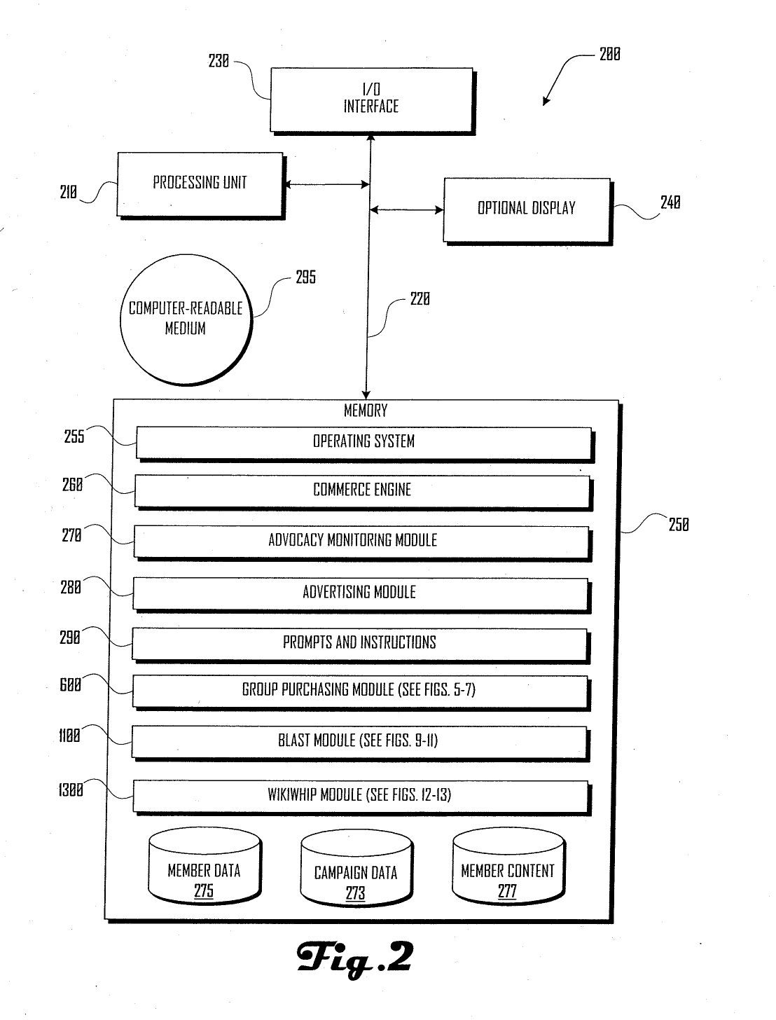

Referring now to FIG. 2, several components of an advocacy server 200 are shown in accordance with one embodiment. In some embodiments, the advocacy server 200 may include many more components than those shown in FIG. 2. However, it is not necessary that all of these generally conventional components be shown in order to disclose an illustrative embodiment.

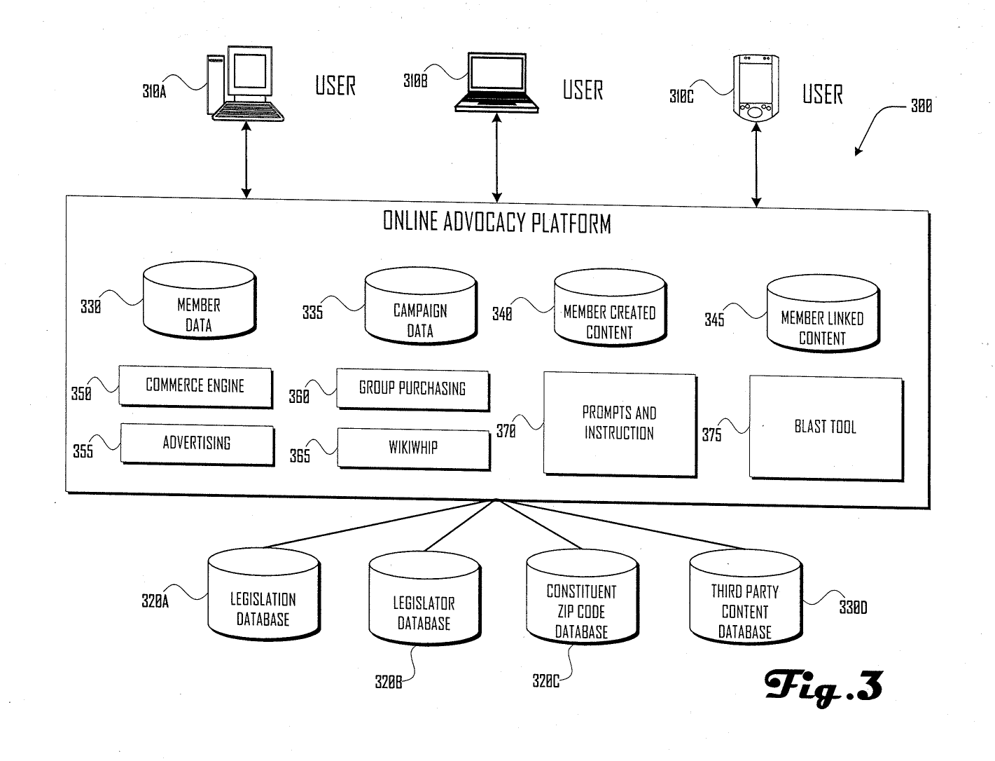

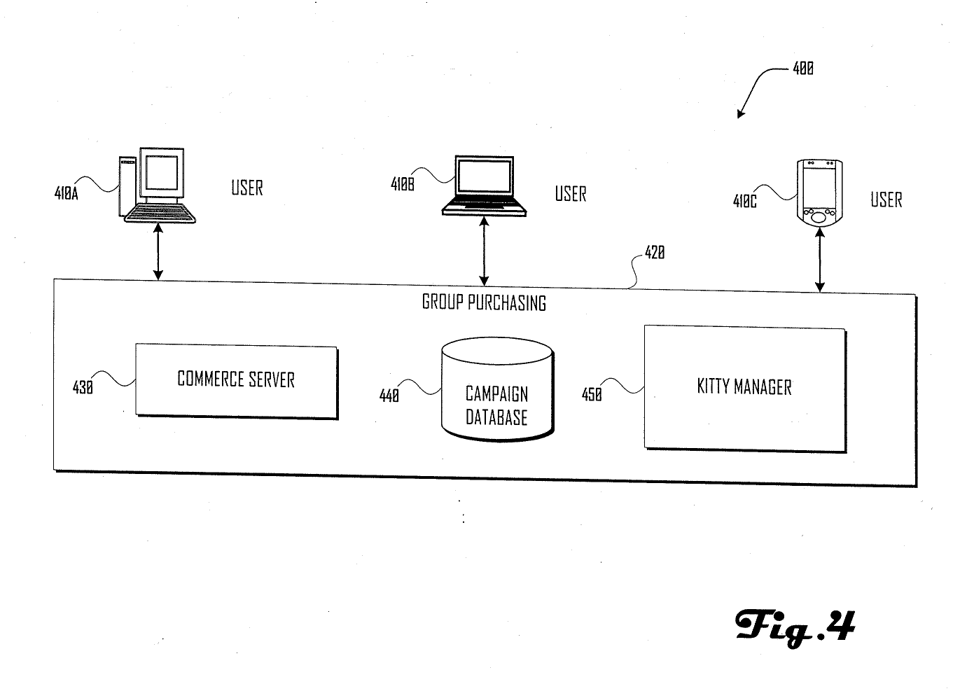

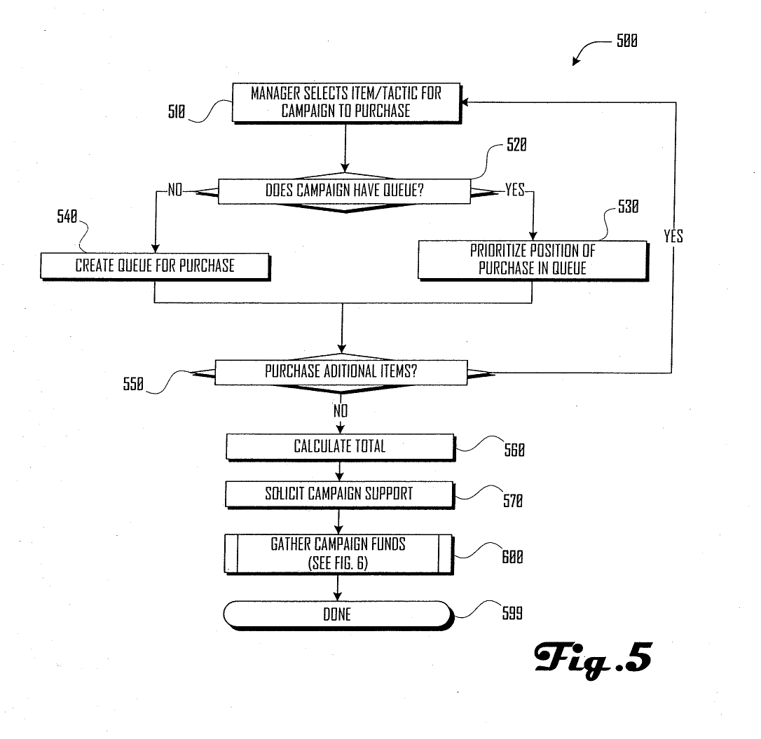

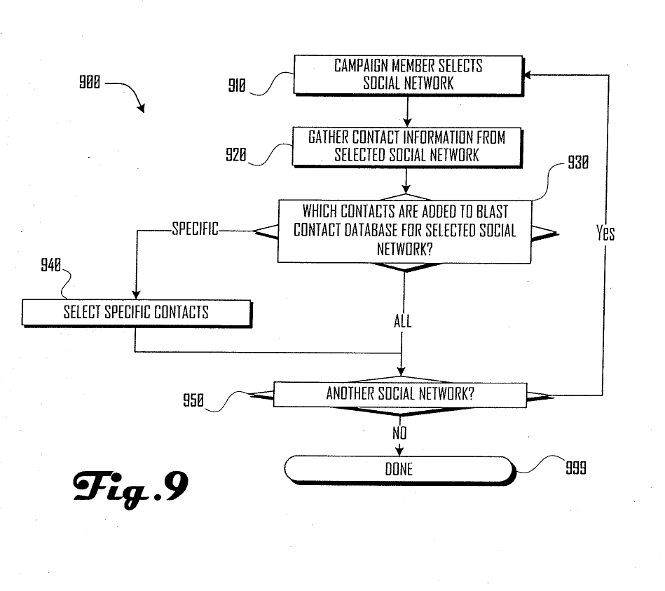

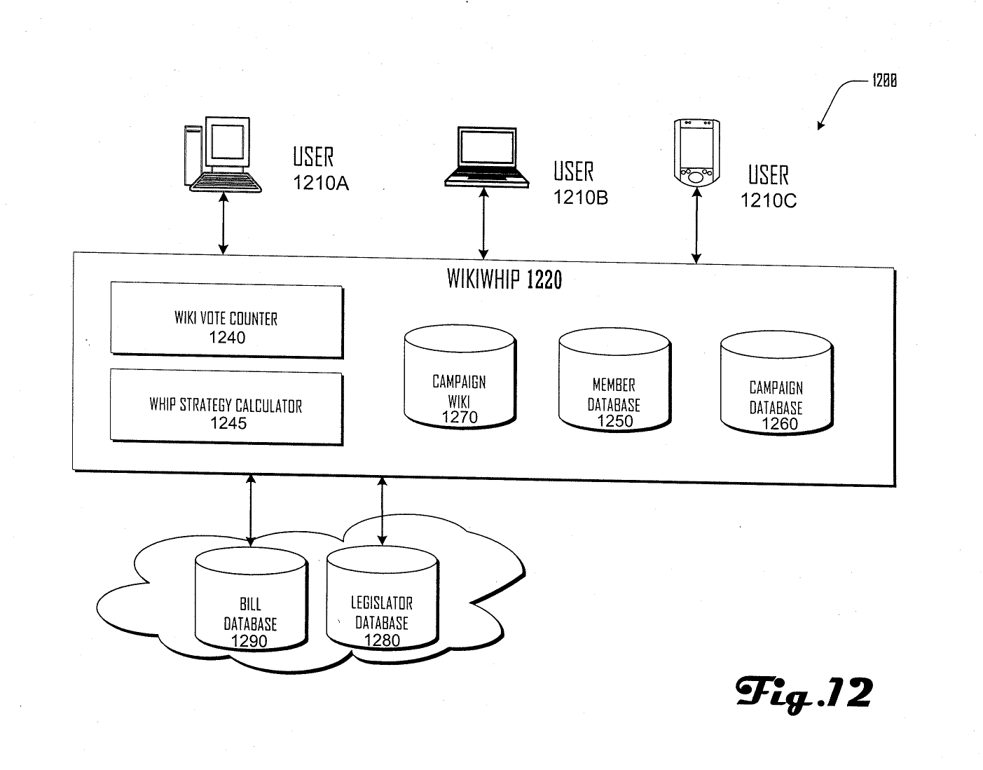

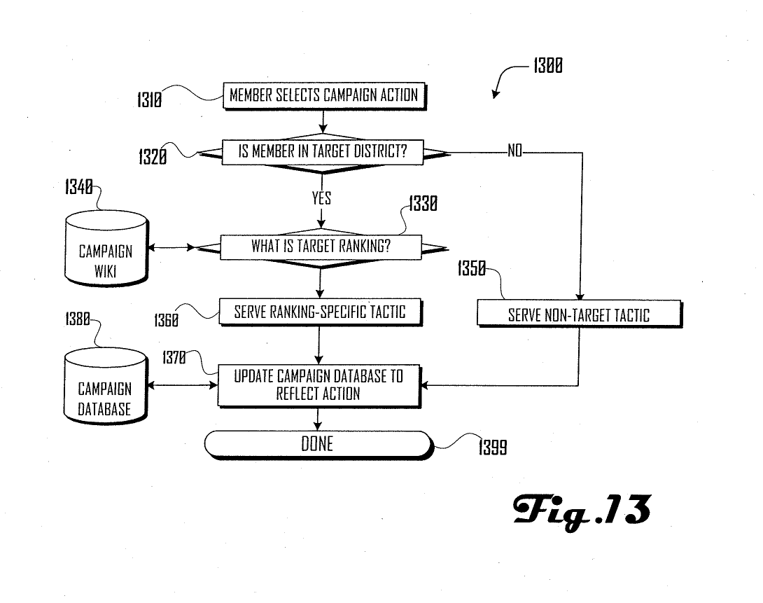

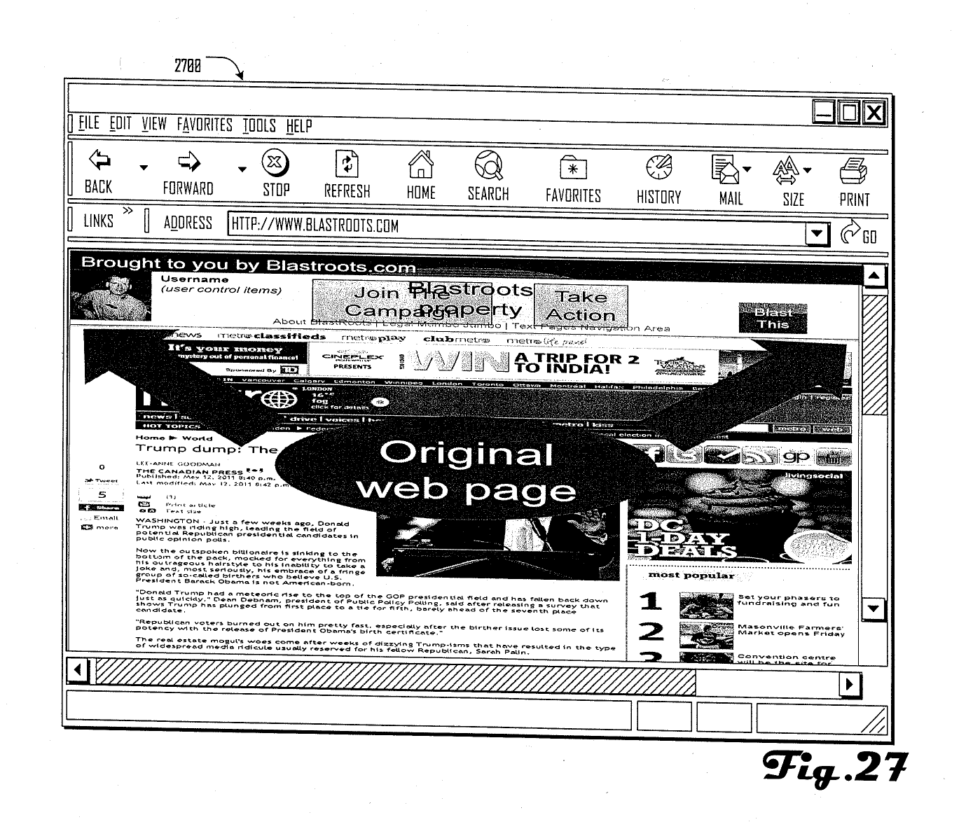

As shown in FIG. 2, the advocacy server 200 includes a processing unit 210, a memory 250, and an optional display 240, all interconnected, along with an Input/Output (I/O) communication interface 230, via a bus 220. The memory 250 generally comprises a random access memory (“RAM”), a read only memory (“ROM”), and a permanent mass storage device, such as a disk drive. The I/O communication interface 230 may connect to a communications network 110, e.g., the Internet. The I/O communication interface 230 may also include a variety of Input/Output ports that each serve as a potential interface between the advocacy server 200 and other computers or peripheral devices and may include Ethernet, FireWire, Serial, Parallel, coaxial cable, and Universal Serial Bus (USB) ports. The memory 250 may store program code for a commerce engine 260, advocacy monitoring module 270, advertising module 280, prompts and instruction routine 290, group purchasing routine 600 (see FIGS. 5-7, discussed below), blast routine 1100 (see FIGS. 9-11, discussed below), and a WikiWhip routine 1300 (see FIGS. 12 and 13, discussed below). As discussed in further detail below, in reference to commerce engine 350 of FIG. 3 and commerce server 430 of FIG. 4, commerce engine 260 may have the ability to collect funds from a plurality of sources and to disburse funds for one or more specified purchases. Advocacy monitoring module 270 may monitor decision maker positions as part of online advocacy platform 300 described below in reference to FIG. 3. Advertising module 280 may generate and/or purchase advertising as discussed in further detail with respect to advertising module 355 of FIG. 3 and FIG. 27. In addition, the memory 250 also stores an operating system 255, campaign data 273, member data 275, and member content 277. These software components may be loaded from a non- transient computer readable storage medium 295, on which the software components are tangibly embodied, into memory 250 of the advocacy server 200 using a drive mechanism (not shown) associated with a computer readable storage medium, such as a floppy disc, tape, DVD/CD-ROM drive, memory card, or the like. In some embodiments, software components may also be loaded via the I/O communication interface 230, rather than via a computer readable storage medium 295. In some embodiments, advocacy server 200 may also communicate via bus 220 with a database (not shown) or other local or remote data store. In various embodiments, bus 220 may comprise a storage area network (“SAN”), a high-speed serial bus, and/or via other suitable communication technology.

Although one embodiment of advocacy server 200 has been described that generally conforms to conventional general purpose computing devices, specifically following a centralized server model, the advocacy server 200 may alternately be any of a great number of devices capable of communicating with other network capable devices. In one embodiment, the advocacy server 200 is a distributed server, such a cloud server providing computational resources on demand via a network. Available cloud resources may include applications, processing units, databases, and file services which may provide massively parallel, horizontal scale-out support architectures that may be easily replicated to enable the advocacy server 200 to handle multiple campaigns at once. For that matter, the scalable architecture enables deployment of a campaign into a variety of target areas, such as individual voting districts, so that correspondence received from those areas may easily be aggregated. In this manner, the advocacy server 200 enables convenient, on-demand network access to a shared pool of configurable asset monitoring and tracking related computing services and resources (e.g., networks, servers, storage, applications, and services) that can be rapidly provisioned and released with minimal management effort or service provider interaction. These services may be configured so that any computer connected to the internet 110 is potentially connected to the group of campaign monitoring and tracking applications, processing units, databases, and files or at the very least is able to submit campaign registration requests, campaign pledge drives, campaign monitoring, and/or access collected campaign information. In this manner, the campaign data maintained by advocacy server 200 may be accessible in a variety of ways by a remote client device, for example, a personal computer, a game console, a set-top box, a handheld computer, a cell phone, or any other device that is capable of accessing the internet 110.

Referring now to FIG. 3, several components of an online advocacy platform 300 are shown in accordance with at least one embodiment. The online advocacy platform 300 interacts with Users 310A-C and third party databases 320A-D. The online advocacy platform 300 includes member data 330, campaign data 335, member created content 340, member linked content 345, commerce engine 350, advertising module 355, group purchasing module 360, WikiWhip module 365, prompts and instruction module 370, and blast tool 375. In some embodiments, online advocacy platform 300 may contain components similar to advocacy server 200 described in FIG. 2. For example, member data 330 may be similar to member data 275, campaign data 335 may be similar to campaign data 273, and member created content 340 and member linked content 345 may be similar to member content 277. Additionally, commerce engine 350 may be similar to commerce engine 260, advertising module 355 may be similar to advertising module 280, and group purchasing module 360 may be similar to group purchasing module 600, Wikiwhip module 365 may be similar to wikiwhip module 300, and blast tool 375 may be similar to blast module 1100.

In one embodiment, the online advocacy platform 300 provides lobbying services to member Users 310A-C and the campaigns they create. More specifically, the online advocacy platform 300 helps a particular campaign with tactic selection, fundraising, group purchasing, lobbying, campaign marketing, campaign content aggregation, and monitoring decision-maker positions. Accordingly, the online advocacy platform 300 maintains specialized data for each campaign that may be used by various platform tools, such as a group purchasing routine, blast tool, and automatic vote whip tool.

Referring now to FIG. 4, several components of an online advocacy platform 400 with a group purchasing system 420 is shown in accordance with one embodiment. In some embodiments, the group purchasing system 420 may include many more components than those shown in FIG. 4. However, it is not necessary that all of these generally conventional components be shown in order to disclose an illustrative embodiment. As shown in FIG. 4, the group purchasing system 420 interacts with remote users 410A-C and includes a commerce server 430, campaign database 440 and kitty manager 450. In one embodiment, the commerce server 430 collects and disperses funds for designated campaign purchases. In one embodiment, the campaign database 440 includes campaign content, member content, and links to member content. The campaign database 440 may also include additional information collected from third party data sources pertinent to the campaign. The kitty manager 450 enables the platform 400 to employ an automated up-front tactic prioritization process, in that one does not have to initiate a separate fundraising effort for every tactic; instead, the group purchasing system 420 would automatically begin raising money for tactics according to settings established by the campaign manager. The kitty manager 450 is also automated to execute a purchase each time the appropriate dollar figure is reached in the campaign kitty for the next tactic.

Traditionally, people who contribute money are not buyers in a transaction because their money goes to a person, not to a purchase. Thus, the end destination is typically a PayPal account, not the fulfillment of a desired transaction to buy or sell. More specifically, many purchase groups say they “organize” group purchases, but they do not execute them. Thus, are not a commerce platform, rather they are purely a communication platform. In contrast, the platform 400 and the group purchasing system 420 provide a campaign with a purchasing tool. In essence, in one embodiment, the group purchasing system 420 provides a shopping cart which, at the point of checkout, after a contract has been reached, gathers the funds from disparate sources to enable and execute the transaction. This provides an ability to gather the funds from disparate sources for a protracted period using online commerce. The protracted payment period enables a campaign to grow organically as money is contributed to the campaign. Accordingly, in one embodiment, the group purchasing system 420 may also include the protracted funding period for purchasing platforms beyond web applications to include digital wallets, credit and debit cards, and even cash.

The online advocacy platform 400 allows the group purchasing system 420 to be used beyond political campaigns. Group purchasing system 420 may be used, for example, to raise funds for a desired purchase for a group (e.g., a neighborhood, an association, a charity, a school, a religious organization, etc.) or for a personal project (e.g., raising funds for tuition for a child or for rebuilding a house). Group purchasing system 420 may also be used for advocacy to achieve a desired result other than a purchase or a political result. For example, neighbors may start a campaign to fund the installation of a new cell tower at an agreed upon price with the vendor, or to solicit a shared ride to the airport, or to commission a performance by a musical group or other entertainer. In this manner, a campaign manager starts the process of selecting the items to purchase, then the payment option is “on hold” while funds are raised. In one embodiment, the group purchasing system 420 of the advocacy platform 400 might be used for gift purchases or even to assist a college student to buy something for school, followed by the student's parents “joining” the campaign and helping to pay for the item. In one embodiment, the group purchasing system 420 of the advocacy platform 400 allows someone to select a target item, and then another person(s) subsequently makes the appropriate financial transaction to cover the associated cost.

In one embodiment, the group purchasing system 420 operates according to a two-step transaction. The first step is where the platform user determines what will go in the shopping cart, and the second step is where an independent entity (the original person coming in at a later date or group/someone else entirely) can access that shopping cart and make partial or full payment on it.

Thus, the advocacy platform 400 will help people organize and pool the financial and productive resources of their friends, acquaintances, and anybody else they can find who will support their cause. The group purchasing system 420 allows people to deploy those resources automatically, turning micro-contributions into large purchases of advocacy services.

Referring now to FIG. 5, a flow diagram is shown of campaign product selection in a group purchasing routine 500 for the advocacy group purchasing system 420 as shown in FIG. 4 in accordance with one embodiment. According to some embodiments, group purchasing routine 500 may be implemented in group purchasing module 360. Beginning in block 510, a selection module in routine 500 (illustrated at block 510) selects target tactics and/or items for purchase by the campaign. In one embodiment, the campaign manager prioritizes the purchase list so that items are purchased in the order that the campaign needs them. Alternatively, one embodiment allows campaign members to select items individually from the manager's list for which they want to contribute. In query block 520, queue module in routine 500 (illustrated at blocks 520, 530, 540, 550, and 560) determines whether the campaign has an established purchase queue. If one already exists, the queue module requests in block 530 that the campaign manager prioritize the new item being added relative to existing items already in the queue. In yet another embodiment, the queue module allows the campaign manager to designate items for inclusion in the queue that expire based on a variety of factors including, time, cost, or campaign viability. Otherwise, the queue module creates a queue for campaign purchases and adds the item to the queue in block 540. For example, an advocacy message, such as a banner ad or search ad on the web, may be targeted to a particular vote. If the advocacy message has not been purchased by the time the vote has passed, the advocacy message campaign item may expire and be removed from the queue. The expiration time for a web banner ad or a search ad may be tied directly to a corresponding vote date. As another example, certain campaign items may require a lead time in advance of a vote that may be calculated by analyzing one or more factors such as a known vote date, an expected time for a purchased item to be delivered (e.g., a mailing time for a letter campaign or a production time for a video), a time for a purchased item to have an impact (e.g., voters to receive and absorb a message), and other factors. Factors may be entered, may be pulled from a campaign calendar, an advertising vendor API, or other sources. A print ad or direct mailing may require a lead time that may vary depending on the size of the campaign, the geographical area to be covered, the contemplated media purchase, specified terms of service, any applicable law, and other factors. A campaign item with a longer lead time that has expired may be removed from a queue or may be converted to a campaign item with a shorter lead time (e.g., a direct mailing campaign that has insufficient lead time left prior to a vote may be converted to a web banner ad).

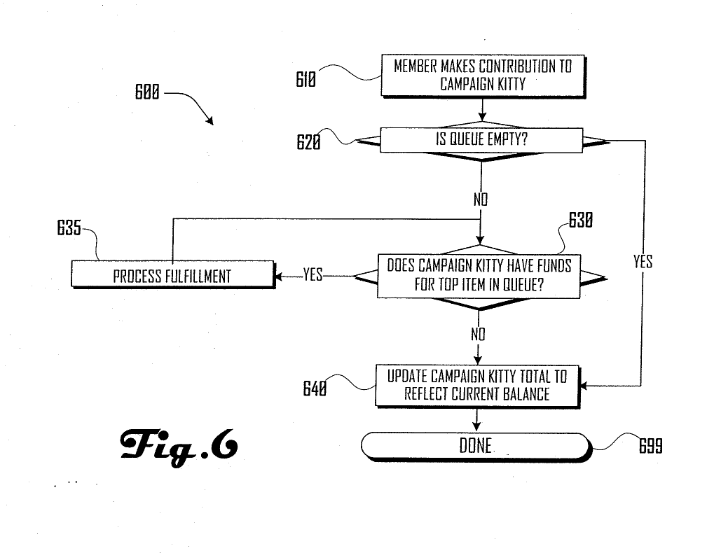

In query block 550, the queue module determines whether the campaign is purchasing any additional items. If additional items are designated, routine 500 returns to block 510. Otherwise, the queue module calculates the queue total in block 560. In block 570, a solicitation module in routine 500 (illustrated at block 570) solicits campaign support for items remaining in the queue. Solicitations may be performed by different methods depending on a solicited target's preference (e.g., email, tweets, a specific social networking page). Solicitations may be generic or they may be customized based on a solicited target, a status of the campaign, and other factors. For example, a solicitation may be targeted to a user via email notifying them that a campaign had received 75% of its funding and urging the user to contribute. If the solicitation is successful, routine 500 gathers campaign funds using a collection subroutine 600 in a collection module (see FIG. 6, discussed below). For example, in one embodiment, a campaign manager may use a group purchasing collection subroutine 600 to aggregate funds for items in the campaign purchase queue. In another embodiment, routine 500 collects payment directly from a campaign manager in collection subroutine 600. After which routine 500 continues to block 599 and ends.

Referring now to FIG. 6, a flow diagram is shown of campaign contribution allocation in a group purchasing routine 600 for the advocacy group purchasing system 420 shown in FIG. 4 in accordance with one embodiment. Beginning in block 610, routine 600 identifies a member contribution to the campaign kitty. In query block 620, routine 600 determines whether the campaign purchase queue is empty. If the campaign purchase queue is empty (i.e., there are funds, but nothing is currently scheduled for purchase), routine 600 continues to block 640. Otherwise routine 600 determines whether the campaign kitty contains sufficient funds to purchase the top item in the queue in query block 630. If the campaign kitty now has enough funds to purchase the top item in the purchase queue, routine 600 continues to process purchase fulfillment using a fulfillment module illustrated in block 635. According to some embodiments, fulfillment may be performed automatically using one or more Application Programming Interfaces (APIs). For example, emails may be generated from an email server, tweets may use a Twitter® API, letters may be generated provided as downloadable files or printed and mailed, phone calls may be performed via a robo-dialer or by connecting a user directly to a target using VOIP, and faxes may be sent using a fax server. Partners may also be used. A fulfillment order for a search ad or banner ad may be automatically routed to a search engine (e.g., Google® or Yahoo®). In one embodiment, routine 600 also removes the purchased item from the purchase queue and continues back to query block 620 to check whether the campaign purchase queue is empty and to query block 630 to see if the campaign kitty has enough after the purchase for the next item in the purchase queue. However, if the campaign kitty, in query block 630, does not yet have enough money to purchase the top item in the purchase queue, routine 600 continues to block 640. Routine 600 updates the Campaign Kitty Total to reflect the current overall balance in block 640. Once the campaign contribution has been properly attributed to the Campaign Kitty and any resulting purchases made, routine 600 continues to block 699 and ends.

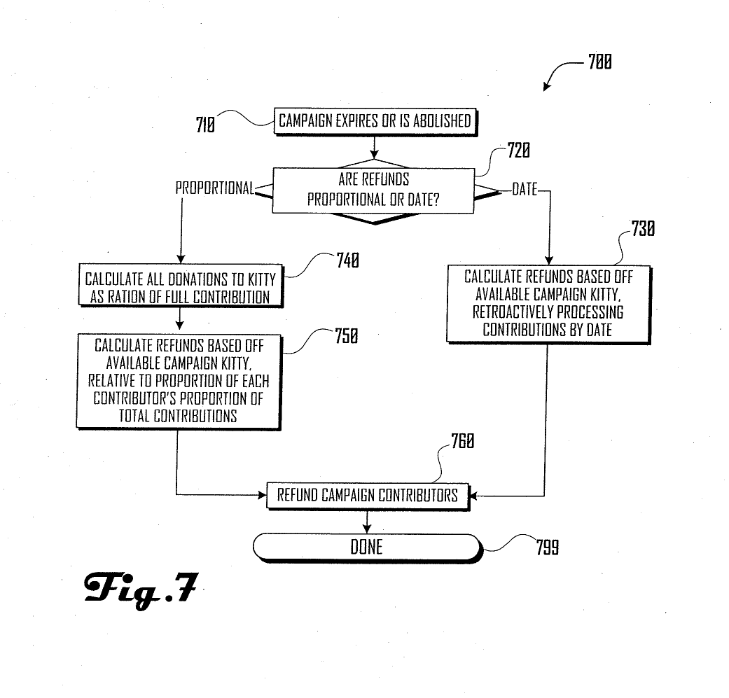

Referring now to FIG. 7, a flow diagram is shown of the refund process associated with the termination of a campaign. More specifically, a refund routine 700 in a refund module (illustrated in FIG. 7) refunds donations made to the general campaign fund that are still in the campaign kitty for the advocacy group purchasing system 420 shown in FIG. 4 in accordance with one embodiment. It should be noted that the refund routine 700 described in FIG. 7 does not, however, affect group purchase funds earmarked for specific projects, because these funds could not have been spent on any other item, and so would just be refunded in full to the original donor when the campaign manager either terminates the campaign or terminates the group purchase. In one embodiment, if the campaign manager decides there is little likelihood of reaching the goal of a specific group purchase fund, the campaign manager could switch the target of the group purchase to a less expensive option. This proposed switch of targets would, in one embodiment, trigger an opt-in message being sent to all donors receiving a refund that encourage the donors to consider donating at least a portion of the refund to a new group purchase target rather than accepting a full refund.

Beginning in block 710 of FIG. 7, routine 700 identifies that a campaign has expired or is abolished by the members. In query block 720, routine 700 determines whether refunds for the general campaign are to be proportional or based on date of the donation. If refunds are based on date, routine 700 calculates the refunds based off available general campaign funds in the campaign kitty and retroactively refunds contributions by date in block 730. In one embodiment, the last contributors are refunded first. Alternatively, in one embodiment, refunds are made to any remaining portion of contributions made by the oldest contributors first. In one embodiment, each contributor is refunded any remaining general contribution portion after intervening purchases have reduced their original contributions on a pro rata basis. For example, a campaign may have received contributions totaling $100,000.00 but only has $10,000.00 at the time of expiration and a first campaign contributor gave $10,000.00 when the campaign opened and a second contributor also gave $10,000.00, but was the very last contributor to the campaign. One embodiment would give the second contributor as the last contributor a full refund and the first contributor no refund. While another embodiment would first determine how many purchases from the campaign queue were made by the campaign after the first contribution and after the second contribution respectively. The refund would then be awarded according to the remaining unspent balance of the contribution. Thus, if all of the purchases were made after both contributions, then the first contributor as the earliest contributor might, according to at least one embodiment, be entitled to a full refund. Alternatively, if the campaign spent part of the first contributor's general contribution before the second contributor made their donation, the first contributor would only be entitled to the unspent portion of donation.

If refunds for the campaign are proportional, routine 700 continues to block 740 and calculates donations to the campaign kitty as a ratio of the full total contribution made to the campaign. Once the relative proportion of the total has been determined, routine 700 calculates in block 750 each proportionate refund based on the available campaign kitty. For example, if a campaign received contributions totaling $100,000.00 and a campaign contributor gave $10,000.00 that contributor would be entitled to 10% of any remaining funds in the campaign kitty. So if the campaign kitty only has $10,000.00 at the time of expiration, the contributor would be entitled to a refund of $1,000.00.

Once the routine 700 determines the refund amount, whether by date or by proportion, the campaign contributors are refunded in block 760. As previously indicated, a variety of alternate and/or equivalent refund implementations may be substituted for the specific refund embodiments shown and described in FIG. 7 without departing from the scope of the present disclosure. Upon refunding the contributors, routine 700 continues to block 799 and ends.

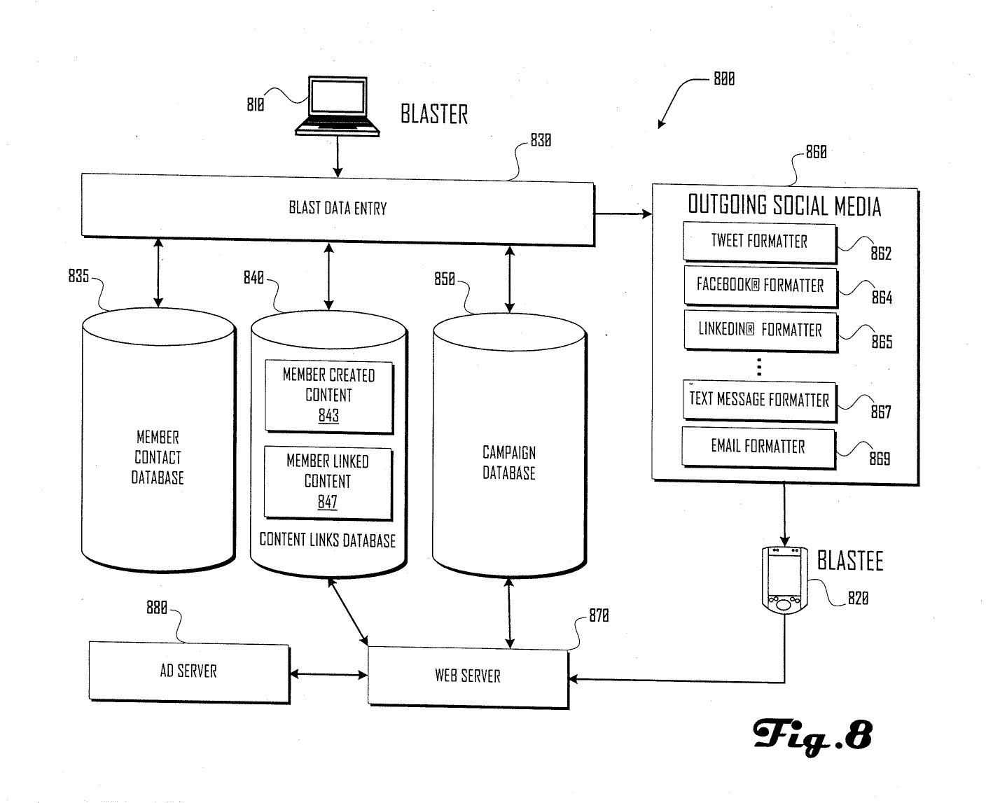

Referring now to FIG. 8, several components are shown of an advocacy blast system 800 in accordance with one embodiment. In some embodiments, the advocacy blast system 800 may include many more components than those shown in FIG. 8. However, it is not necessary that all of these generally conventional components be shown in order to disclose an illustrative embodiment. As shown in FIG. 8, the advocacy blast system 800 interacts with a blaster 810 and a blastee 820. The blaster 810 is typically a campaign member, but it may also be a user wanting to share campaign content, such as an article, with their contacts. The blastee 820 is generally a contact of a campaign member, but may also be a campaign member, public official, and/or policymaker. The advocacy blast system 800 includes a blast data entry module 830, member contact database 835, content links database 840, campaign database 850, outgoing social media formatter 860, web server 870 and ad server 880.

In one embodiment, the content links database 840 includes identification of member created content 843 and member linked content 847. In one embodiment, the campaign manager may designate individuals to approve both format and content of blast messages. In one embodiment, the member linked content 847 represents links approved by the campaign and may be used by other campaign members to create their blast message. Member created content 843 also includes content approved by the campaign.

In various embodiments, the outgoing social media formatter 860 includes several format modules configured to reformat a blast message in accordance with the rules and standards required for each social network. Illustrative examples of the formatting modules in the outgoing social media formatter 860 include tweet formatter 862, Facebook formatter 864, Linkedln formatter 865, text message formatter 867, and email formatter 869. In this manner, a campaign member can easily access contacts in each of their social networks and automatically send a blast message specially formatted for that social network platform. For example, a blast tool might allow users to sign in to Facebook through the advocacy website, and provide the user with an option to select a particular set of individuals and/or groups that they would like to contact within their Facebook network, such that each time they “Blast” out a message and/or link, the site automatically posts it on Facebook, though only to those the user has designated, if the user has limited the distribution on Facebook. Similarly, the tweet formatter 862 allows a campaign user to designate Twitter as a target social network. The blast tool allows users to sign in to Twitter through the site, and select followers they would like to direct message and/or hashtags they would like to be added to anything they “Blast” out, such that what they Blast can be tweeted out, with shortened text and tinyURL links if necessary, to the designated recipients only, and/or along with designated hashtags. In one embodiment, blast postings can be virtually simultaneous, if the Blaster 810 has set up and designated both networks, so that a Tweet of the blast message is sent via Twitter the same time the blast message is posted on Facebook. Other illustrative blast examples include, allowing users to sign in to Linkedln through the blast tool, and select which groups and individuals they would like to post to and/or if they wish to restrict their activity, such that what they Blast out can be posted through the user's Linkedln network but only to those they designate, if possible. A single Blast can go to multiple social media formats. For example, a blast can be addressed to multiple emails, Facebook®, Twitter®, a blog posting, a recorded robo-call (e.g., a VOIP based call), Short Message Service (SMS), and other destinations. A user may pick one or more social media platforms based on a message, the user's contacts on a particular social media platform, and other factors.

In one embodiment, the ad server 880 will display an advertisement in the portion of the webpage labeled as BlastRoots property in FIG. 27. This will particularly be the case when the blasted content is user generated. In one embodiment, the ad displayed by the ad server 880 will be the result of a third party buying advertising space from BlastRoots, to display to campaign members, campaign managers, and other such users. In one embodiment, other ad tactics selected by the campaign manager and/or approved by the campaign might be served by the ad server 880. Illustrative ad tactics include newspaper ads, radio ads, and robocalls within a targeted geographic area. In one embodiment, the ad server 880 provides a paid search ad in Target's Geographic Area associated with language used in blasts from campaign members. The targeted ad helps drive traffic to the campaign, using the title of the campaign for key words, to help drive others to the cause in targeted areas. In other embodiments, the ad server 880 may generate banner ads for use in a Target's Geographic Area that the campaign member would be able to design or select, to actually advocate for the positions of the campaign. A targeted ad may be directed towards a geographical region in which a vote is close or a politician is undecided. For example, if the Simpson Bowles Plan was within a few votes of passing, targeted ads may be used in congressional districts of Representatives who were opposing the Plan or were undecided. Ads may be bought by congressional district accordingly.

Referring now to FIG. 9, a flow diagram illustrates campaign blast participant selection in a blast routine 900 for the advocacy blast system 800 shown in FIG. 8 in accordance with one embodiment. Beginning in block 910, routine 900 allows a campaign member to select a social network. In block 920, routine 900 gathers contact information from the selected social network. For example, where a campaign member designates Facebook® as the social network, the routine 900 may request a list of the campaign members “friends” directly from Facebook®. This may be done using a Facebook® API, a native Facebook® application, or other methods. A contact list of friends may be generated. Once a contact list has been assembled for a member on a particular social network, routine 900 queries the campaign member in block 930 to identify which contacts are to be added to the blast contact database for the selected social network. Thus, a member may designate communication with the same contact via different social networks for each campaign (e.g., via checkboxes). If the member designates blasting only specific contacts, routine 900 prompts selection of the contacts for that social network in block 940. Otherwise routine 900 will blast all contacts of the campaign member in the designated social network (e.g., a Facebook® message or a wall post on Facebook®). In query block 950, routine 900 determines whether the campaign member wants to select contacts from another social network for inclusion in the blast. If another social network is selected routine 900 returns to block 910. Otherwise routine continues to block 999 and ends. According to some embodiments, a recipient of a blast may choose to follow or subscribe to blasts of a sender. In some embodiments, a sender may receive a communication requesting that the recipient be added to one or more lists or campaigns.

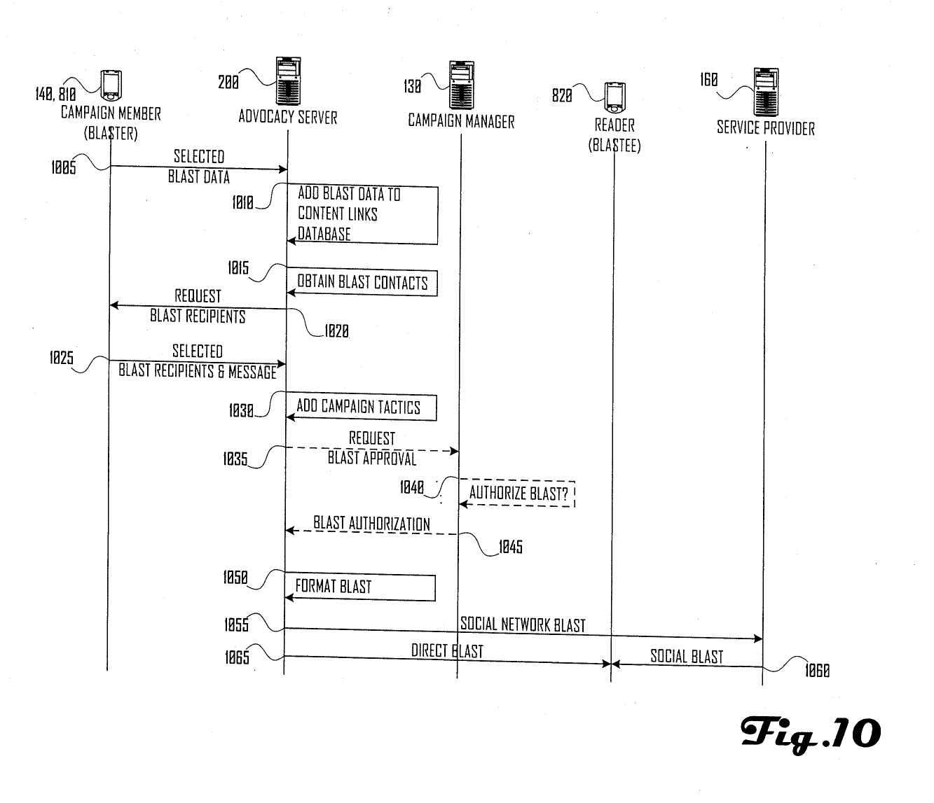

Referring now to FIG. 10, a series of communications are shown between a campaign member (140, 810), an advocacy server 200, a campaign manager 130, a reader 850, and a third party service provider 160 in accordance with one embodiment. The illustrated series of communications shows one scenario in which a campaign member (140, 810) or blaster elects to send either a social network blast or direct blast to a reader or targeted campaign blastee. The illustrated sequence of events is provided as an example for illustrative purposes. In other embodiments, a similar message publication process may be obtained via a different sequence of events.

Beginning the illustrated sequence of operations, campaign member (140, 810) submits 1005 selected blast data for inclusion in a message blast to the member's social network. Typically, the selected blast data includes content or a link to content and may also include a personalized message regarding the data. To include a link, the member may cut and paste a link or URL to a story of interest. Or, the member may click on a widget on a news site or a browser toolbar widget that launches a blast composition page with a reference (e.g., a link) to the webpage story of interest, or use other methods.

Upon receiving the blast data for inclusion into a direct campaign blast the advocacy server 200 adds 1010 links to blast data to a member linked content database 847 and adds other member created content to a member created content database 843.

Upon adding the blast data, advocacy server 200 obtains blast contacts 1015 based on the campaign member sending the blast data and interested followers of the campaign. In particular, the advocacy server 200 identifies targets for the proposed blast and requests 1020 selection of blast recipients from the campaign member (140, 810). The transmitting 1025 campaign member or Blaster, selects appropriate blast recipients and creates a personal message for possible inclusion in the blast. Upon receiving the identified blast recipients and any associated messages, the advocacy server 200 adds 1030 the campaign tactics to the blast to conform the message to campaign standards. The campaign tactics may include, for example, the desired campaign products (e.g., emails, tweets, petitions for signing, regular mail, and recruitment.) The advocacy server 200 optionally requests 1035 approval for the blast from the campaign manager 130. Upon review, the campaign manager 130 may optionally authorize 1040 the blast and return 1045 a blast authorization to the advocacy server 200. Upon receiving authorization, the advocacy server 200 formats 1050 the blast in accordance with accepted standards or templates established for the campaign. The format may include a blast supplied header with external content below (e.g., an external webpage in a frame). The blast supplied header may contain one or more user supplied elements such as, for example, a link to a campaign or petition related to the external content. The blast supplied header may be designed to accommodate in a frame a particular external content site that hosts a blast widget. Once properly formatted, an approved social network blast is sent 1055 to the social network provider 160 by the advocacy server 200 and published 1060 to the target reader 820. In the case of a directed message blast, the advocacy server 200 sends 1065 a blast directly to the target reader 820. One illustrative example of a blast using an online advocacy platform (“BlastRoots”) frame and an embedded link to campaign content found at an external website is illustrated in greater detail in FIG. 27.

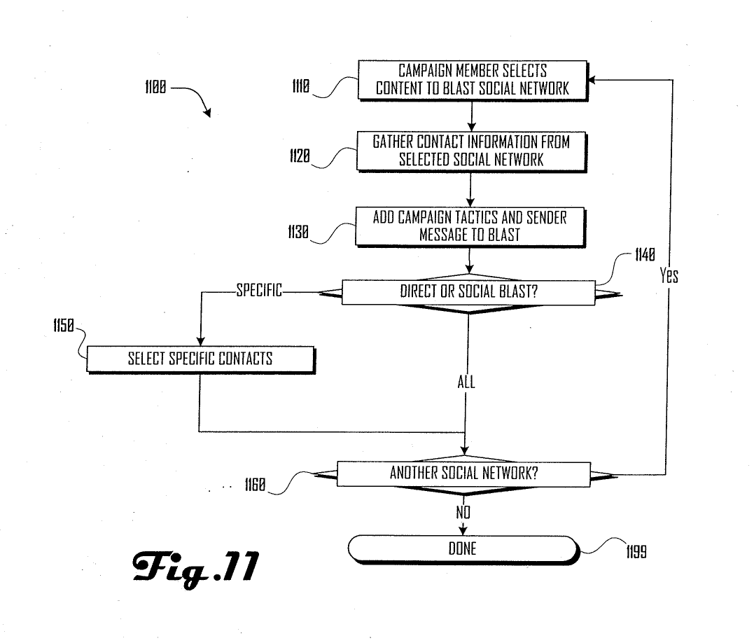

Referring now to FIG. 11, a flow diagram is shown of campaign blast message compilation in a blast routine 1100 for the advocacy blast system 800 shown in FIG. 8 in accordance with one embodiment. Beginning in block 1110, routine 1100 allows a campaign member to select content for inclusion in a blast to a selected social network. In block 1120, routine 1100 gathers contacts from the selected social network for inclusion in the blast. In block 1130, routine 1100 applies tactics associated with the campaign to the previously selected content and personalized message data, if any, from the campaign member. This content is then combined into blast content available via a blast link. The blast content may be displayed on a web page with selected blast actions in a header. In one embodiment, blast actions include joining the campaign, taking a requested action, and supporting a campaign sponsor. Once blast content has been selected, routine 1100 may specially format the content for the particular social network. For example, tweets may have shortened content and may contain a hashtag, URL or tinyURL for more detail. Email may contain much more content directly in the body of the email. A posting may be further formatted for a social network based on an API used to access a particular social network or the context of a social network. A Facebook® wall posting may contain less content than an email but more than a tweet. In query block 1140, routine 1100 determines whether the blast content is for a directed blast (e.g., email, saved blast contact list, or direct social network message) or a social blast (e.g., post to general social network). If it is a directed blast, routine 1100 selects specific contacts to receive the blast in block 1150. Once the contacts have been selected for a social network, routine 1100 sends to the selected contacts a direct email or social network message with a blast link in block 1160. If the blast is a social blast, routine 1100 sends the blast to all of the approved campaign members contacts in that social network by posting a blast link or the blast content to the public portion (e.g., wall) of the social network in block 1170. In query block 1180, routine 1100 will determine if another social network is to be included in the blast. If another social network is designated, routine 1100 returns to block 1120 to gather contact information for the next social network included in the blast. Otherwise routine 1100, determines in query block 1185 whether the blast contact list should be saved so that the campaign member can blast future messages to the same group of people again without having to go through the whole contact selection process again. In one embodiment, the saved blast contact list may be a type of directed blast selected by routine 1100 in query block 1140. One embodiment may optionally include contacts in the saved blast contact list from even more than one social network. If a saved blast contact list is requested, routine 1100 saves the blast contact list for future reuse in block 1190. In block 1195, the content of the current constructed blast is displayed with selected blast actions. Otherwise routine 1100 just displays blast content with blast actions in block 1195. In one embodiment, displaying blast content may include sending a link to the blast content. When a recipient of the blast follows the link, the blast content is displayed on the recipient's device. One embodiment of routine 1100 continues to block 1199 and ends.

Referring now to FIG. 12, several components of an online advocacy platform 1200 with an advocacy WikiWhip system 1220 are shown in accordance with one embodiment. In some embodiments, the advocacy WikiWhip system 1220 may include many more components than those shown in FIG. 12. However, it is not necessary that all of these generally conventional components be shown in order to disclose an illustrative embodiment. As shown in FIG. 12, the advocacy WikiWhip system 1220 may interact with remote users 1210A-C and/or a third party legislative monitoring service 1230. The advocacy WikiWhip system 1220 includes a wiki vote counter 1240, a whip strategy calculator module 1245, a member database 1250, a campaign database 1260, and a campaign wiki 1270. In one embodiment, the third party legislative monitoring services 1230 provide the advocacy WikiWhip system 1220 with access to a legislator database 1280 and a bill database 1290.

Referring now to FIG. 13, a flow diagram is shown of a WikiWhip strategy calculator routine 1300 for the advocacy WikiWhip system 1200 shown in FIG. 12 in accordance with one embodiment. Beginning in block 1310, routine 1300 receives a request by a campaign member to select a particular campaign action.

In query block 1320, routine 1300 determines whether the campaign member is in a target district for the campaign. In one embodiment, the target district represents at least one of a legislative district and/or a congressional district. In one embodiment, a target district represents individuals living within a designated area on one of a state map, a congressional district map, a legislative district map, a county map, a city map, school board map, and the like. In one embodiment, a campaign identifies targets and potential members according to a candidate's ideological proximity to a campaign, rather than a geographical proximity. Thus, a campaign may select potential targets exhibiting a certain ethical set of ideals, principles, doctrines, myths, or symbols associated with a particular ideology of the campaign. In one embodiment, members of a campaign are self-selecting.

If the campaign member is in the target district, routine 1300 determines the target ranking in query block 1330. In some embodiments, a target ranking may be based on the value of campaigning for a particular vote or the likelihood of influencing a vote of a particular legislator. For example, an undecided legislator may be ranked highest and a legislator already strongly in favor of the campaign may be ranked lowest. If the campaign member is not in the target district, routine 1300 serves an approved non- target campaign tactic in block 1350, updates a campaign database 1380 in block 1370 to reflect the action taken, and ends in block 1399. According to some embodiments, if a campaign member is not in a target district, a campaign member may be advised to employ a campaign tactic in a target district (e.g., contribute to the campaign in a district other than their own in order to achieve greater impact).

In one embodiment, routine 1300 may determine the target ranking from information obtained via a query of a campaign wiki 1340 that may include intelligence reports, documents, video, sound and other links to support the target rank. Upon determining the target ranking, routine 1300 serves a ranking specific campaign tactic in block 1360, updates the campaign database 1380 in block 1370 to reflect the actions taken, and ends in block 1399.

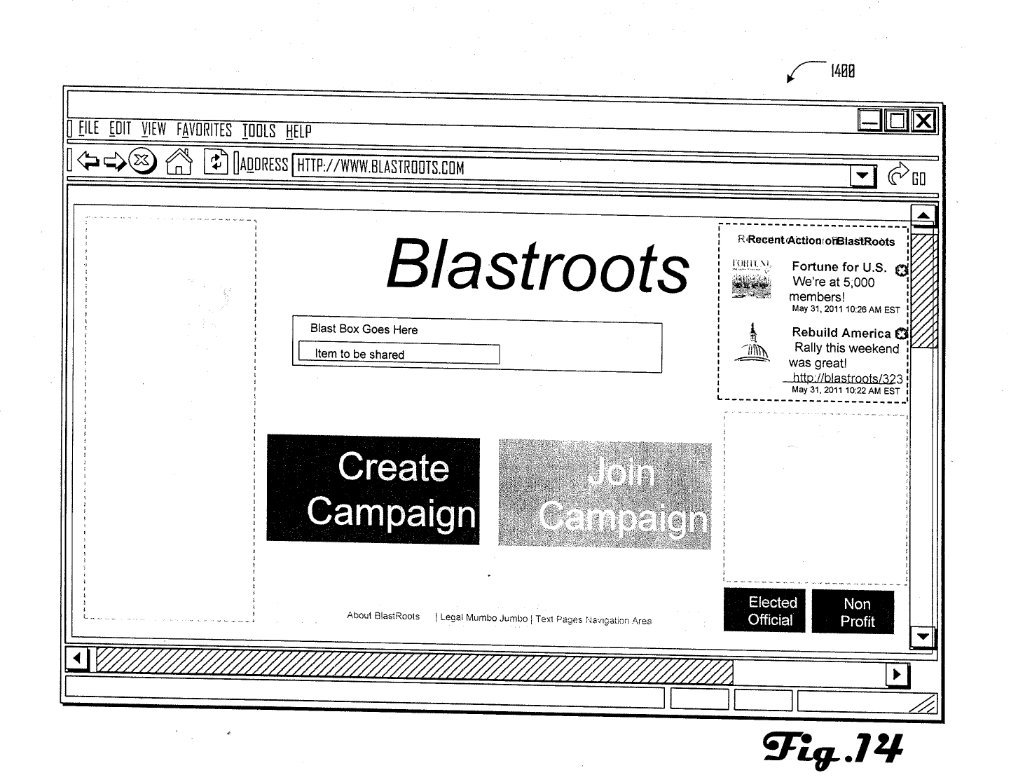

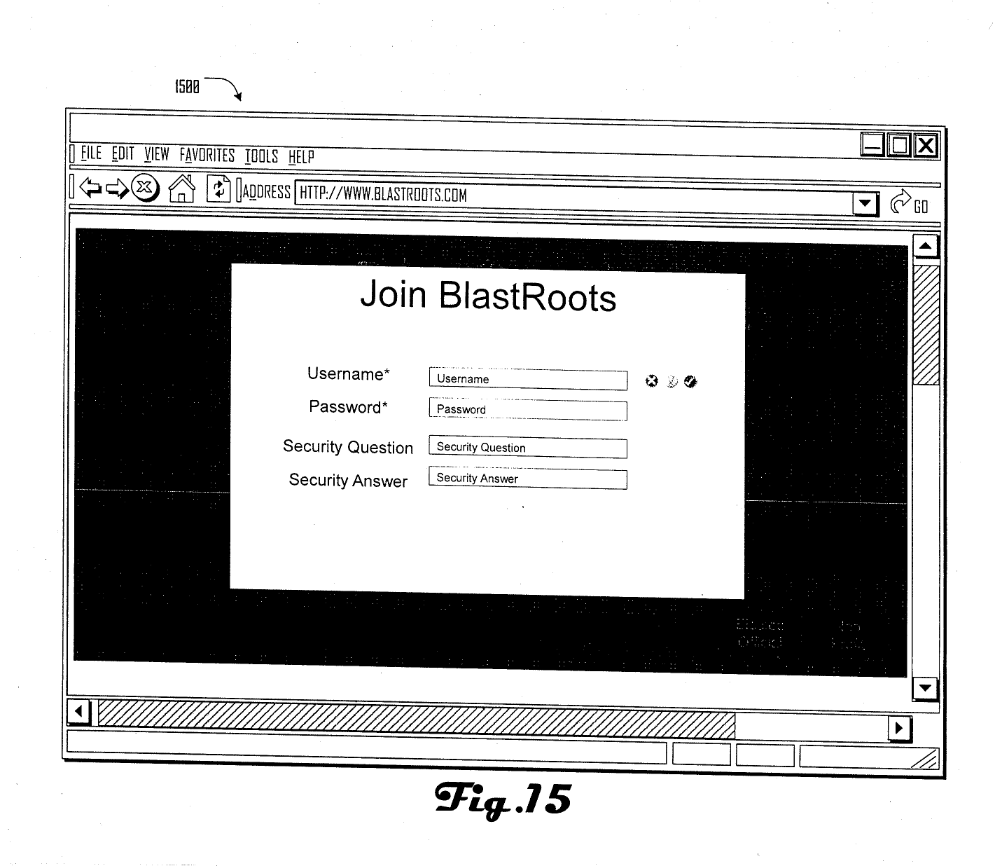

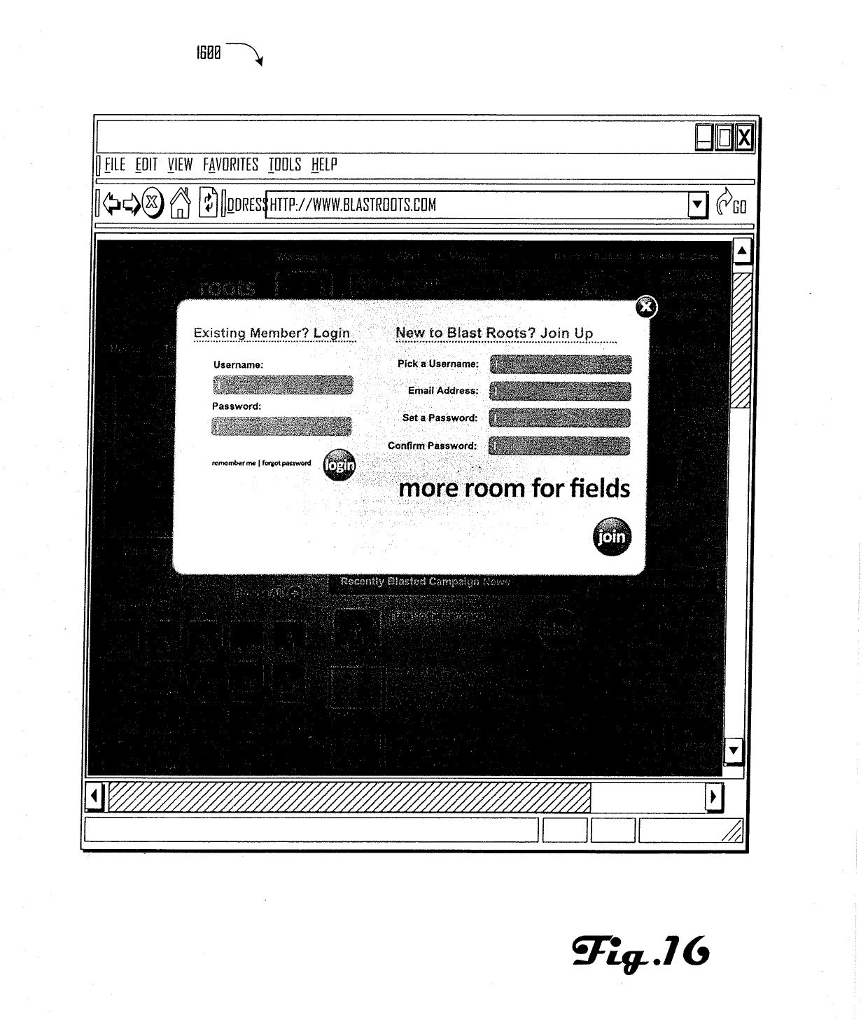

Referring now to FIG. 14, a screenshot illustrates prompting a new user to select a campaign in accordance with one embodiment. In FIG. 15, a screenshot illustrates a new user log-in page prompting user registration for secure participation in a selected campaign in accordance with one embodiment. A screenshot of a combined member/new user log-in page is shown in FIG. 16 in accordance with one embodiment.

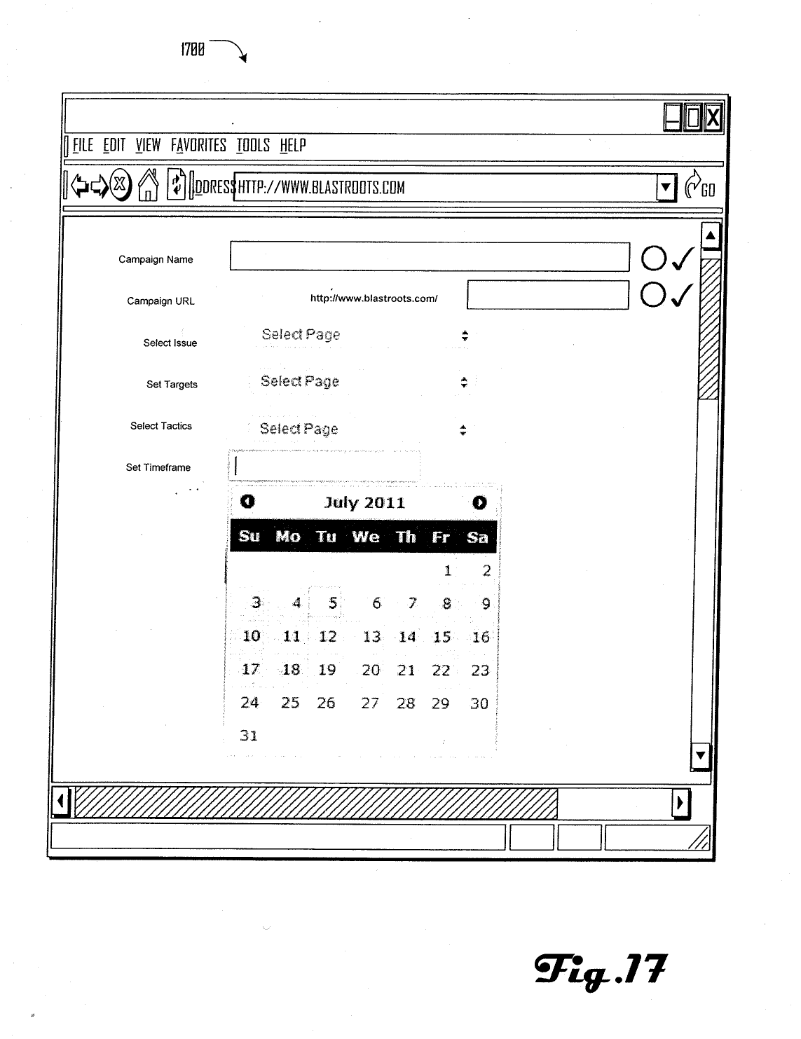

Referring now to FIG. 17, a screenshot of a management page for a new campaign is illustrated. The illustrated webpage solicits a new campaign title and web address from the campaign manager. Among other prompts, the page prompts a campaign manager for issue selection, target identification, and tactic selection for a campaign in accordance with one embodiment. In one embodiment, a timeframe for completing the campaign may also be established.

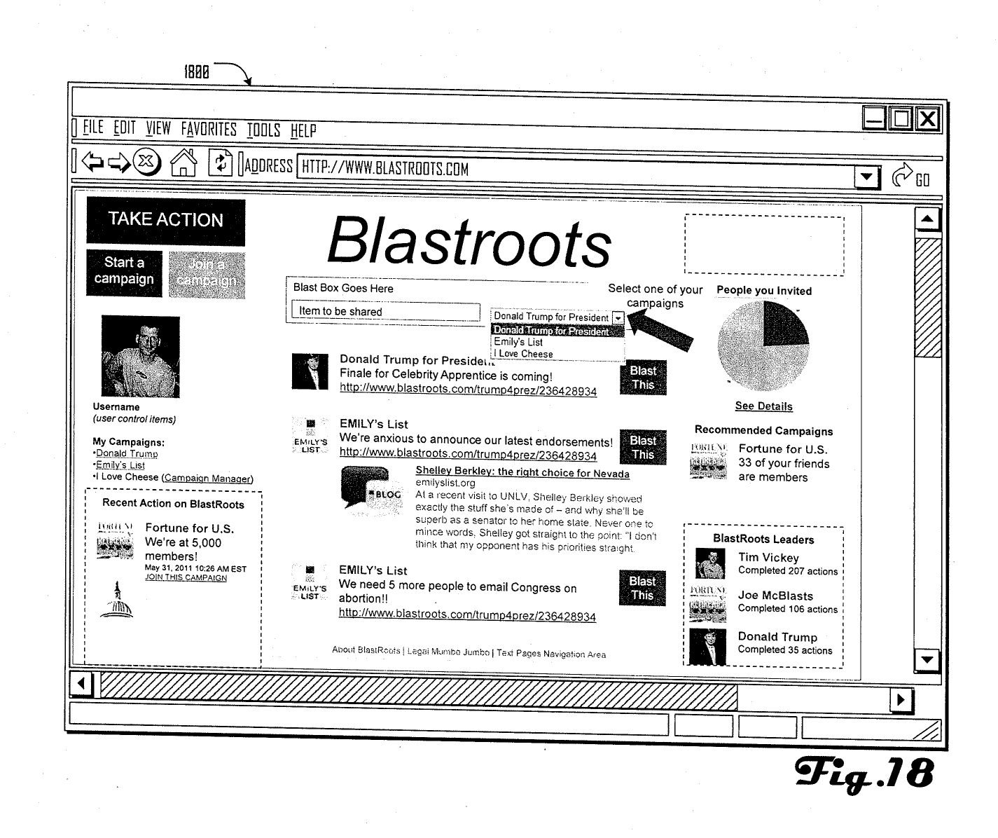

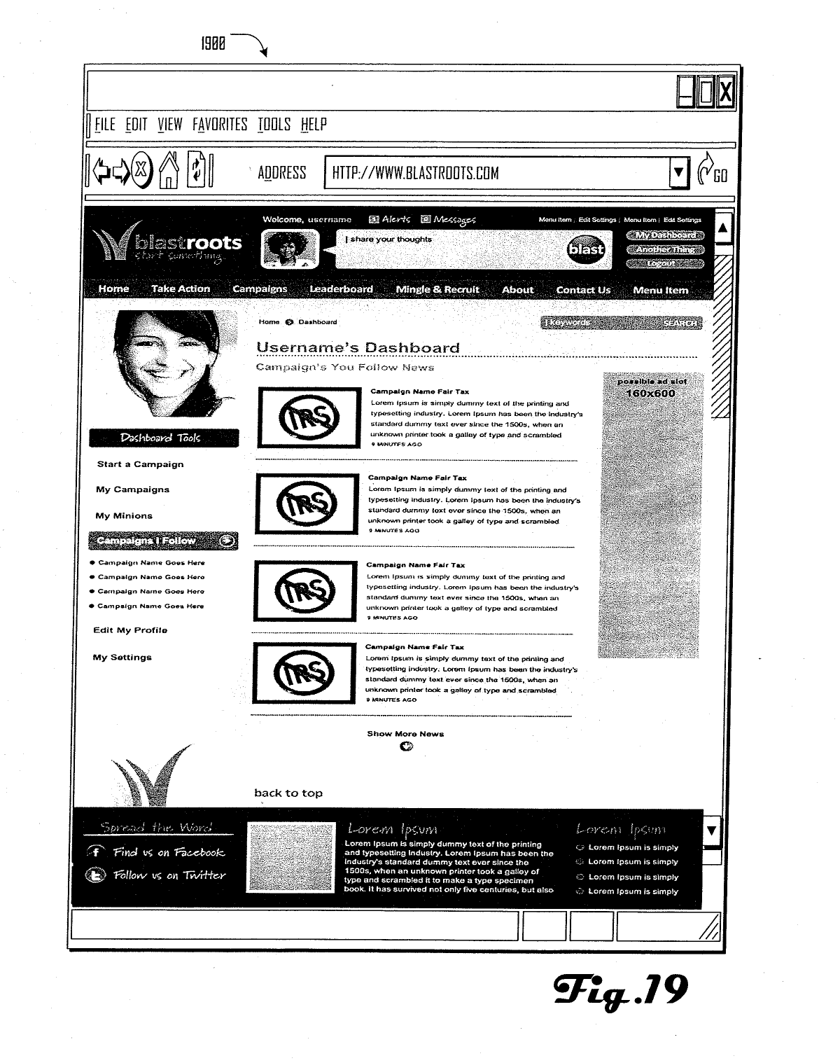

Referring now to FIG. 18, a screenshot shows a member dashboard with a consolidated aggregate campaign newsfeed drawn from a collection of member campaigns in accordance with one embodiment. The page provides options to take action by, for example, starting or joining a campaign, and provides options to select a campaign already joined. The newsfeed items can be blasted using the widget (indicated by “Blast this”), as discussed above. One or more campaigns may be selected to blast to. A graph shows a percentage of people who have joined a particular campaign out of total people invited. Recommended campaigns for a user to join may also be displayed (e.g., based on friends' memberships, current campaign memberships, and other factors). A listing of recent campaign actions (e.g., a membership level being reached for a particular campaign) may also be displayed. A screenshot of another member dashboard populated with member campaigns is shown in FIG. 19 in accordance with one embodiment. Links to one or more member campaigns may be provided. Options may be provided to start a campaign, to blast a message, edit a user profile, and to access additional advocacy actions.

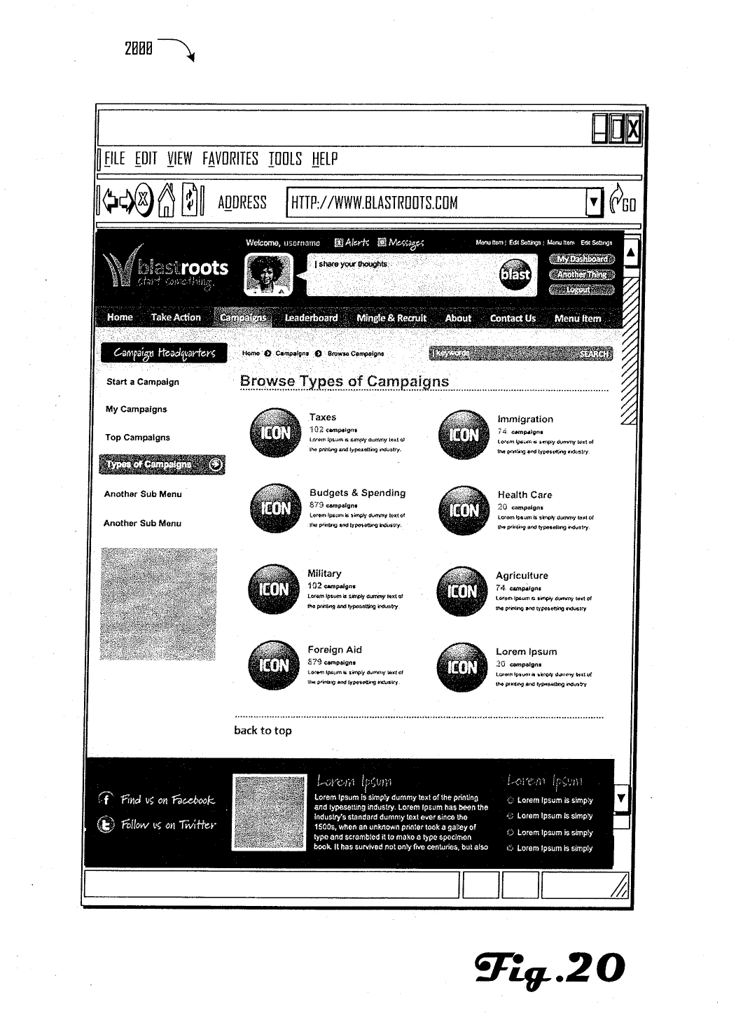

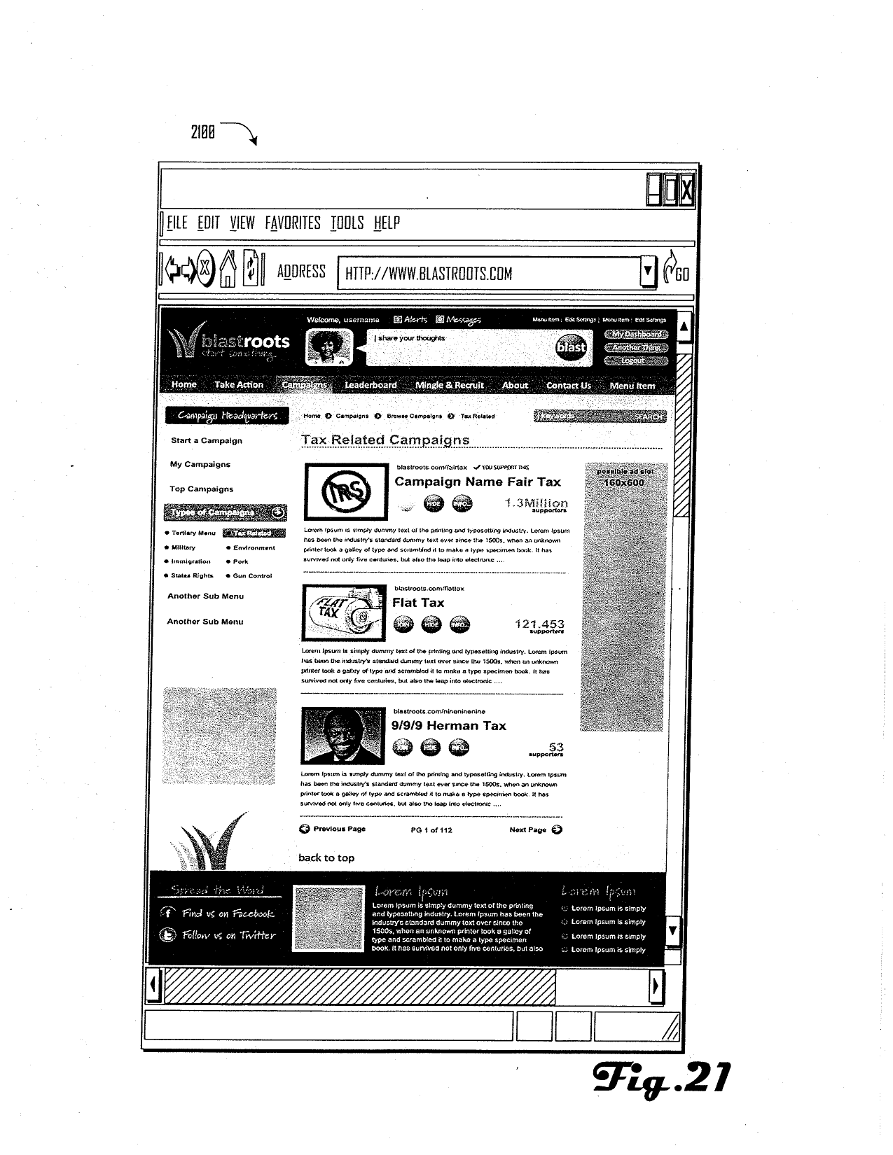

Referring now to FIG. 20, a screenshot of a topic-related campaign index is shown for members in accordance with one embodiment. A user interface for browsing campaign may be provided. Navigation of campaigns may be grouped hierarchically by types of campaigns, by top campaigns, by recently added campaigns, by most active campaigns, by campaigns associated with a user, by campaigns associated with a friend of a user, by campaigns with most members, by campaigns with the most funds, by campaigns with the closest action items (e.g., vote or fundraising deadline), or by other factors or groupings. A user may perform a keyword search for a campaign based on one or more of a campaign title, a campaign objective, a decision maker or legislation associated with a campaign, a member associated with a campaign, a campaign deadline or other campaign attributes. Different options may be provided for following and/or joining a campaign. For example, notification or contact preferences may be specified indicating how a member would prefer to be contacted with respect to a particular campaign (e.g., email or tweet only at specified milestones of a campaign). FIG. 21 illustrates a screenshot of topic-related campaigns for member self-affiliation in accordance with one embodiment. For example, within a particular grouping or search category of campaigns a listing of campaigns may be provided. The listing of campaigns may be sorted, filtered, and/or further processed in response to one or more user preferences or inputs (e.g., show only campaigns at a state level or above, or only campaigns with greater than a specified number of members).

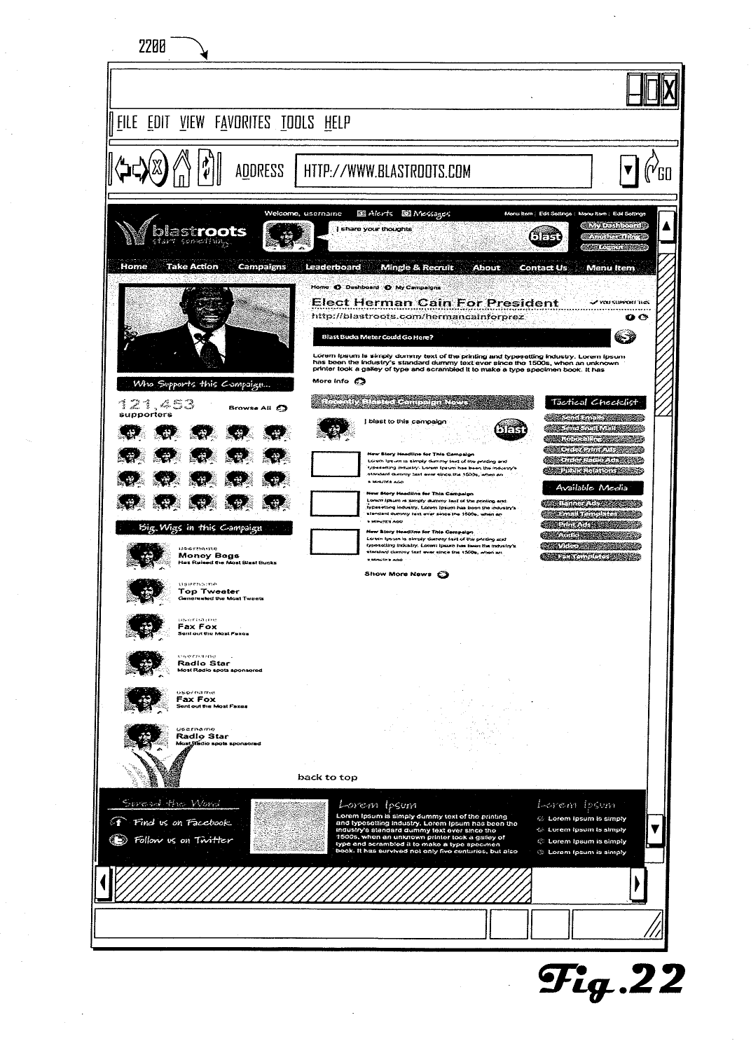

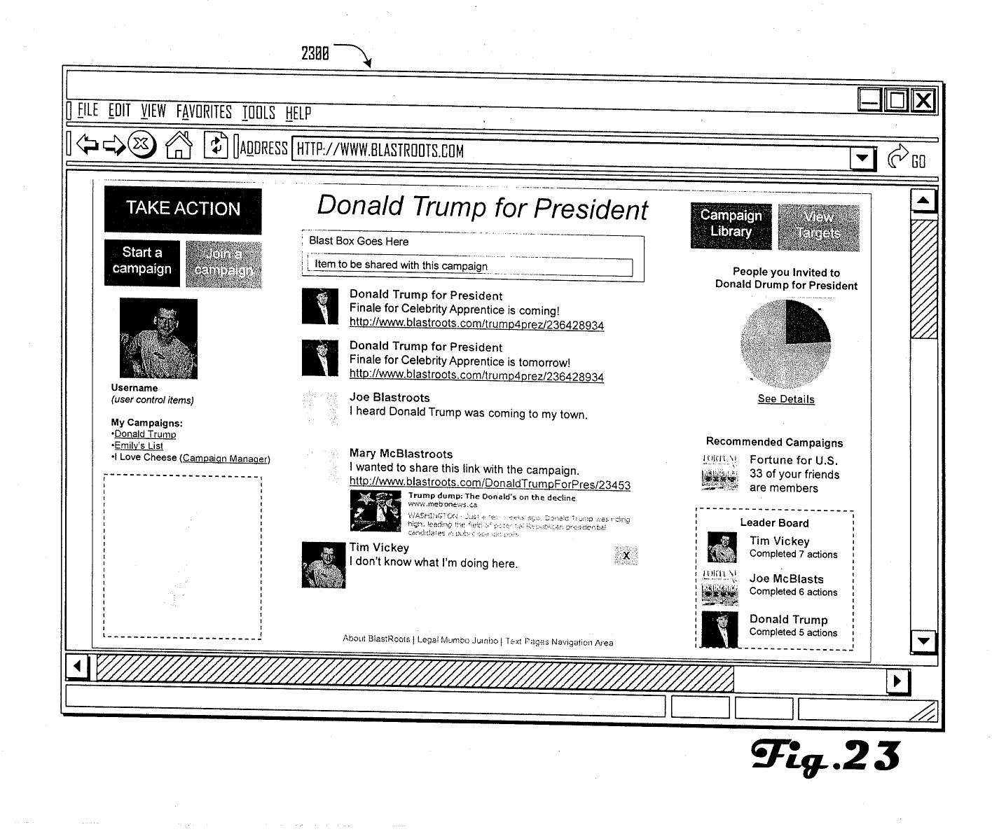

Referring now to FIG. 22, a screenshot illustrates a campaign profile in accordance with one embodiment. Details of a particular campaign may be provided. Campaign details including recently blasted campaign news, a count of campaign supports, a list of top supporters (e.g., by financial contributions, activity, assigned campaign role, political connections, or other factors), and other campaign actions may be provided. A tactical checklist of planned, performed, and/or possible campaign actions may be provided (e.g., user controls for sending email, sending postal or snail mail, initiating turbo-calling, ordering print ads, ordering radio ads, or contacting public relations). Links to available media may be provided (e.g., via APIs to media partners such as Google or Yahoo for web ads, to other partners for radio or TV ads, or to internal resources such as email templates). FIG. 23 illustrates a screenshot of a campaign dashboard for campaign members with a campaign newsfeed in accordance with one embodiment. The page provides options to take action by, for example, starting or joining a campaign. An interface for sending a blast message may be provided. A graph shows a percentage of people who have joined a particular campaign out of total people invited. Recommended campaigns for a user to join may also be displayed (e.g., based on friends' memberships, current campaign memberships, and other factors). A listing of a user's campaigns may also be displayed.

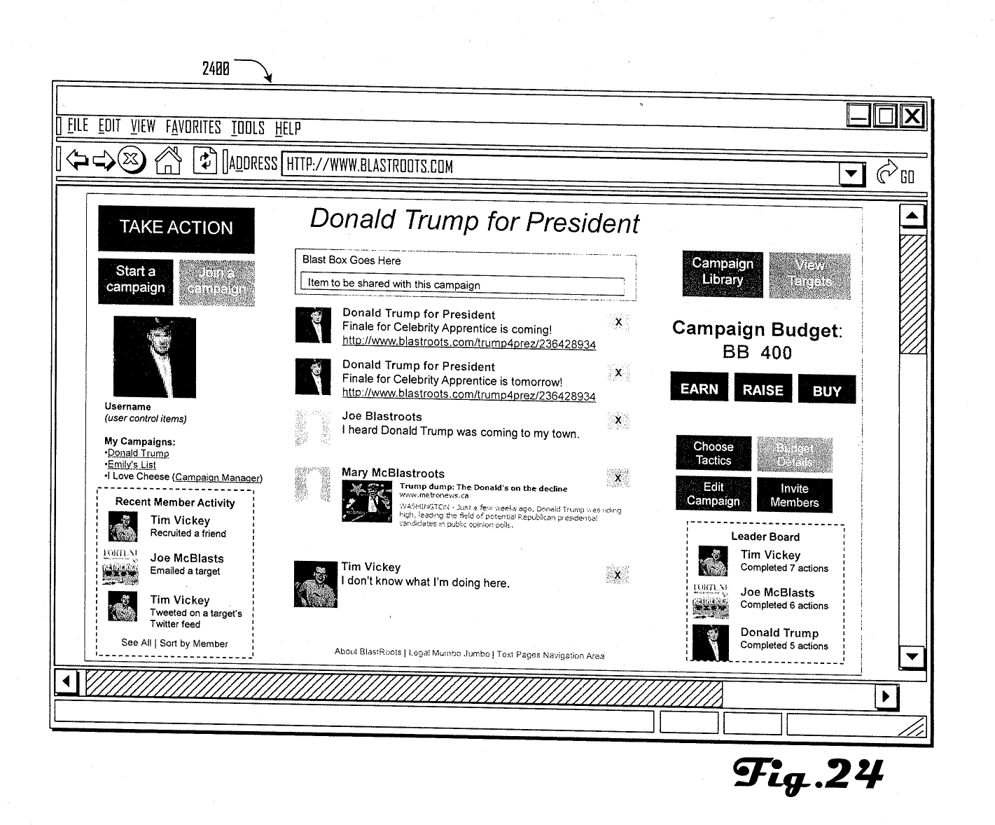

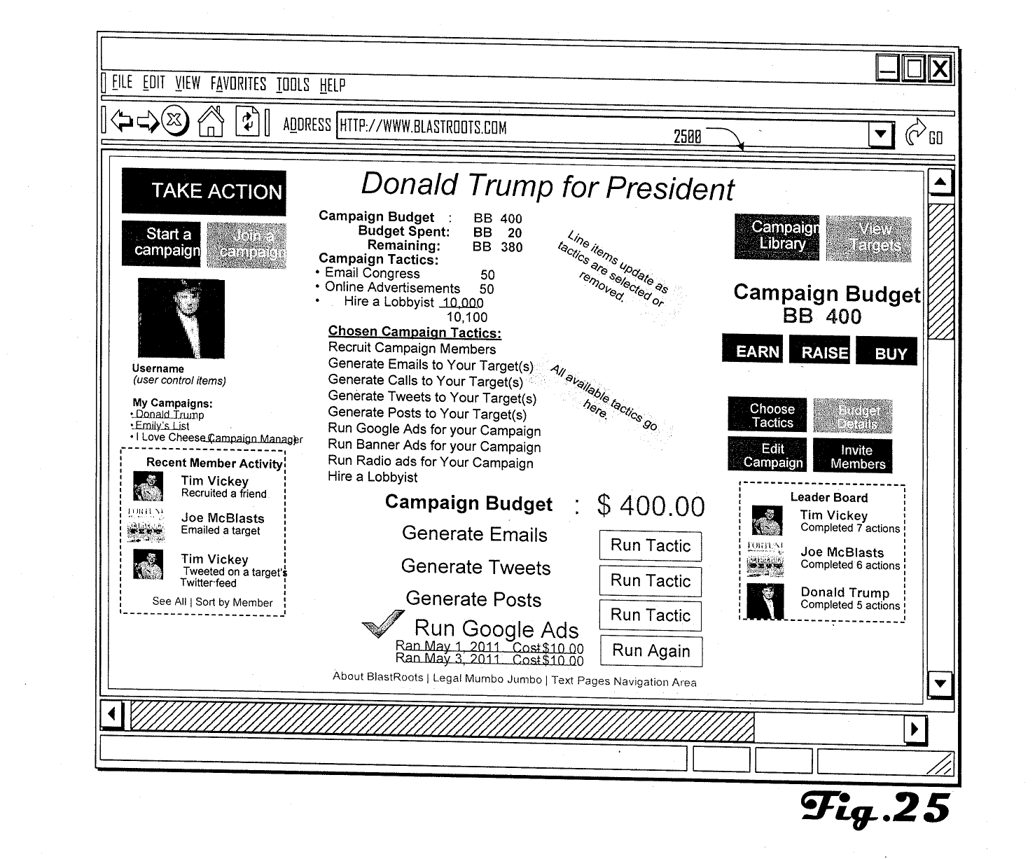

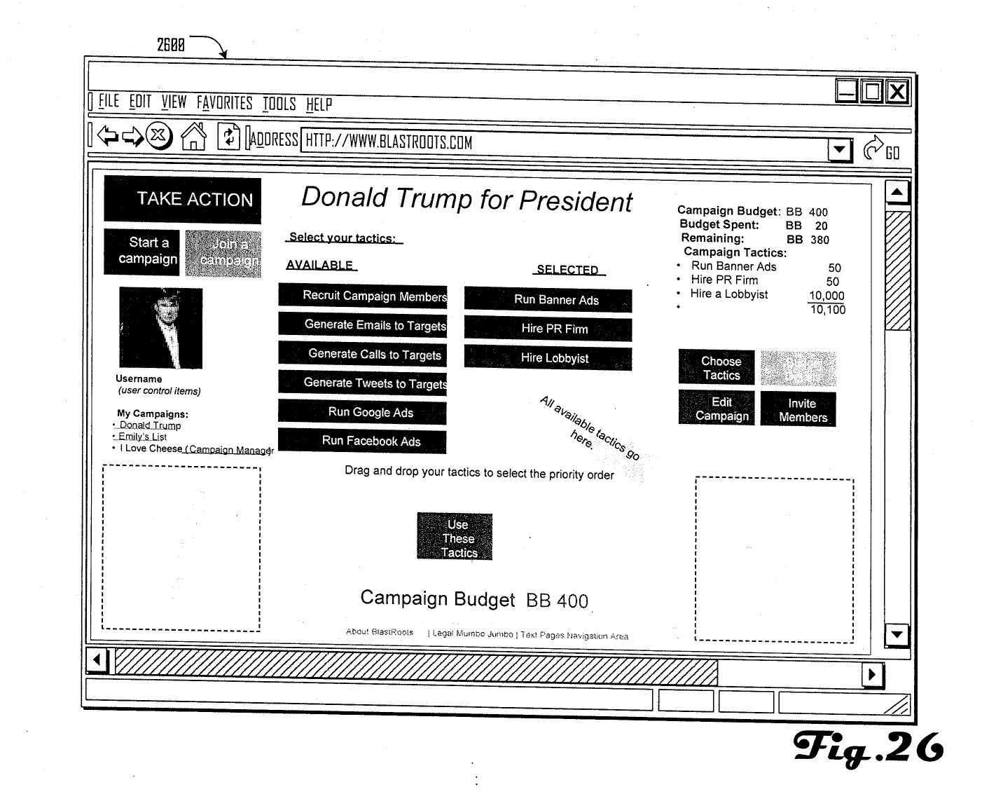

The advocacy server 200 assists a campaign manager 130 with tactic selection, fundraising, group purchasing, lobbying, campaign marketing, and campaign content aggregation, and monitoring decision-maker positions. Examples of various embodiments are shown in FIGS. 17, 24-27. FIG. 17 illustrates a screenshot of a management page for a new campaign. The page prompts the campaign manager for target and tactical selection for the campaign in accordance with one embodiment. A campaign management page may provide a user interface for one or more campaign members to set campaign attributes. For example, a campaign manager and a campaign founder may be able to set attributes such as, campaign name, campaign URL, an issue associated with a campaign, a target associated with a campaign, a tactic associated with a campaign, and a timeframe associated with a campaign. FIG. 24 illustrates a screenshot 2400 of a campaign dashboard for a campaign manager 130 with a campaign newsfeed in accordance with one embodiment. A campaign dashboard may provide a user interface for a campaign member to perform one or more campaign actions such as, for example, creating a campaign library, choosing a campaign tactic, viewing budget details, editing campaign details, and inviting campaign members. FIG. 25 illustrates a different screenshot 2500 of a campaign budget dashboard for a campaign manager 130 in accordance with one embodiment. A campaign dashboard may provide campaign budget details, specify campaign tactics details (e.g., a number and type of contacts to a decision maker such as a legislator), and a listing of chosen campaign tactics (e.g., generating emails, calls, tweets, and/or posts to one or more targets, running ads, hiring a lobbyist, and performing other actions). A history of past tactics may be provided (e.g., when one or more past tactics were tried). FIG. 26 illustrates a screenshot 2600 of a campaign tactical advocacy strategy selection page for campaign managers 130 in accordance with one embodiment. A campaign tactical advocacy strategy selection page may indicate available campaign tactics, selected campaign tactics, and a priority order of selected campaign tactics. Campaign manager 130 may be able to select campaign tactics and set a priority for campaign tactics. According to some embodiments, one or more suggested priorities may be provided which may be influenced by deadlines for tactics, cost of a tactic, budget, and other factors. FIG. 27 illustrates a screenshot 2700 of a blasted campaign content page in accordance with one embodiment that conforms to selected campaign tactics and format. As discussed above, blasted campaign content may embed data from an external source within a campaign page (e.g., via a frame). According to some embodiments, a size of a campaign header may be designed to accommodate content from a known external source (e.g., an agreement may be reached for an interface with an external content provider).

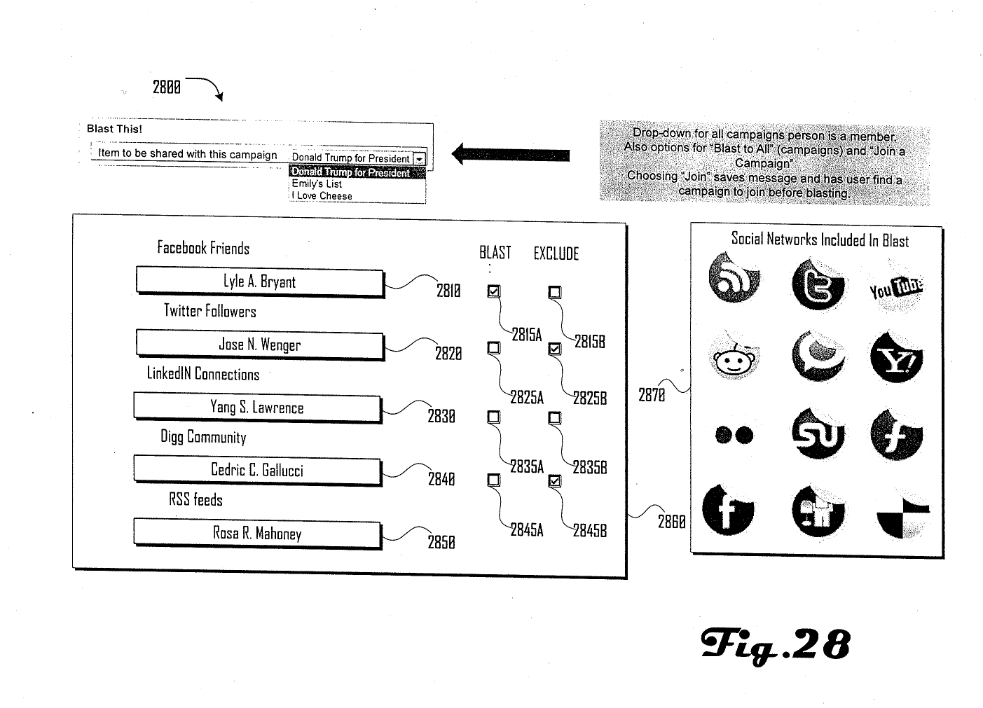

Referring now to FIG. 28, a blast box 2800 for social networking advocacy with a drop down campaign menu is shown in accordance with one embodiment. The blast box 2800 dynamically allows a campaign member to quickly post campaign content to a campaign feed or individual wall, tweet a campaign message, create an RSS feed of a campaign's blasts, email campaign messages, and send individual messages to personal contacts. In one embodiment, the characteristics of the blast box 2800 are established upon joining a campaign.

Thus, in one embodiment, users are immediately asked to setup their blast preferences and select any number of communication tools available for use by a particular campaign. For example, an individual might authorize postings to a wall or tweets, but restrict use of email. In one embodiment, blast preferences may be duplicated from another campaign. In one embodiment, illustrated in pop-up box 2860, a campaign member may designate whether to include/exclude individuals from different social networks in blasts from that campaign. For example, a Facebook® friend 2810 may be included via selected checkbox 2815A in future blasts regarding “Donald Trump for President” while a particular Twitter follower 2820 is excluded via selected checkbox 2825B. This blast inclusion designation is typically done during setup, but may also be revisited and adjusted by the campaign member at any point.

As previously indicated, the advocacy server 200 may maintain several campaigns at once. Accordingly, a user may also be a member of several different campaigns on the social networking advocacy platform. In one embodiment, the dropdown menu includes all campaigns that a user is a member of so that the member may easily share content across multiple campaigns. Exemplary icons for third party service providers active with a particular campaign are also illustrated in box 2870 of FIG. 28. In one embodiment, the active third party service providers included in the blast box may be adjusted relative to each campaign member and each campaign. Box 2870 includes a variety of icons associated with different active social media platforms for the “Donald Trump for President” campaign, such as Facebook®, Twitter®, RSS, YouTube®, Yahoo®, LinkedIn, StumbleUpon, Delicious, Technorati, Digg, Reddit, Furl, and Flickr. Other social media platforms provide a variety of acceptable alternate and/or equivalent implementations and are not considered beyond the scope of this disclosure. Examples of additional social networks that might be configured to work with the online advocacy platform include Google+, Orkut, Habbo, Blogster, Tumblr, Plaxo, Badoo, hi5, Bebo, Ibibo, douban, Flixster, Foursquare, Friendster, Kiwibox, Mixi, Taringa, Myspace, Netlog, Open Diary, Qzone, Renren, Tagged, Vkontakte, Windows Live Spaces, WiserEarth, Xanga, and the like.

Although specific embodiments have been illustrated and described herein, a variety of alternate and/or equivalent implementations may be substituted for the specific embodiments shown and described without departing from the scope of the present disclosure. This application is intended to cover any adaptations or variations of the embodiments discussed herein.

1.-20. (canceled)

21. A system for advocacy efforts using social networks comprising:
an online site hosting information associated with an advocacy effort to influence a decision of a decision maker;
a strategy calculator module operating within one or more processors coupled to a network configured to:
provide a plurality of advocacy actions available to influence the decision maker;
receive input selecting an advocacy action from an online user interface of the online site; and
a fulfillment module configured to:
perform the advocacy action using one or more electronic actions to influence the decision maker, wherein the one or more electronic actions comprise at least one of: generating an email, connecting a user to the decision maker using a VOIP based call, generating a tweet, generating a posts to a social media website, sending an order for an online advertisement, sending a fax using a fax server, and generating a letter for postal delivery.
